(19) United States
(12) Patent Application Publication
(10) Pub. No.: US 2026/0073673 A1
(43) Pub. Date: Mar. 12, 2026

(54) INTER-VEHICLE FUSION FEATURE REPRESENTATION TRANSFER

(71) Applicant: QUALCOMM Incorporated, San Diego, CA (US)

(72) Inventors: Thorbjoern Sven JEMANDER, Linköping (SE); Gustav Nils Ture PERSSON, Ljungsbro (SE)

(21) Appl. No.: 18/827,423

(22) Filed: Sep. 6, 2024

(51) Int. Cl. G06V 10/80; G06V 10/82; G06V 20/58

(52) U.S. Cl. CPC G06V 10/803; G06V 10/82; G06V 20/58; G06V 2201/08

(57) ABSTRACT

Systems and techniques are described herein for vehicle communications. For example, a computing device of a first vehicle can generate, using one or more encoders, one or more first tensors based on first sensor data obtained from one or more first sensors of the first vehicle. The computing device can obtain one or more second tensors from a second vehicle. The one or more second tensors are associated with second sensor data obtained from one or more second sensors of the second vehicle. The second sensor data includes information associated with one or more regions obscured from the first sensor data. The computing device can generate an output based on the one or more first tensors and the one or more second tensors.

### FIELD

The present disclosure generally relates to vehicle communications. For example, aspects of the present disclosure relate to inter-vehicle fusion (e.g., low-level fusion) feature representation (e.g., tensor) transfer.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (cMBB), massive machine type communications (mMTC), and ultra-reliable low latency communications (URLLC). Some aspects of 5G NR may be based on the 4G Long Term Evolution (LTE) standard. Aspects of wireless communication may include direct communication between devices, such as in vehicle-to-everything (V2X), vehicle-to-vehicle (V2V), and/or device-to-device (D2D) communication. There exists a need for further improvements in V2X, V2V, and/or D2D technology. These improvements may also be applicable to other multi-access technologies and the telecommunication standards that employ these technologies.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for inter-vehicle fusion feature representation (e.g., tensor) transfer. In some aspects, an apparatus for vehicle communications at a first vehicle is provided The apparatus includes at least one memory and at least one processor coupled to the at least one memory and configured to: generate, using one or more encoders, one or more first tensors based on first sensor data obtained from one or more first sensors of the first vehicle; obtain one or more second tensors from a second vehicle, wherein the one or more second tensors are associated with second sensor data obtained from one or more second sensors of the second vehicle, the second sensor data including information associated with one or more regions obscured from the first sensor data; and generate an output based on the one or more first tensors and the one or more second tensors.

In some aspects, a method is provided for vehicle communications at a first vehicle. The method includes: generating, by one or more encoders of the first vehicle, one or more first tensors based on first sensor data obtained from one or more first sensors of the first vehicle; obtaining one or more second tensors from a second vehicle, wherein the one or more second tensors are associated with second sensor data obtained from one or more second sensors of the second vehicle, the second sensor data including information associated with one or more regions obscured from the first sensor data; and generating an output based on the one or more first tensors and the one or more second tensors.

In some aspects, a non-transitory computer-readable medium is provided having stored thereon instructions that, when executed by at least one processor, cause the at least one processor to: generate, using one or more encoders, one or more first tensors based on first sensor data obtained from one or more first sensors of the first vehicle; obtain one or more second tensors from a second vehicle, wherein the one or more second tensors are associated with second sensor data obtained from one or more second sensors of the second vehicle, the second sensor data including information associated with one or more regions obscured from the first sensor data; and generate an output based on the one or more first tensors and the one or more second tensors.

In some aspects, an apparatus for vehicle communications is provided. The apparatus includes: means for generating one or more first tensors based on first sensor data obtained from one or more first sensors of a first vehicle; means for obtaining one or more second tensors from a second vehicle, wherein the one or more second tensors are associated with second sensor data obtained from one or more second sensors of the second vehicle, the second sensor data including information associated with one or more regions obscured from the first sensor data; and means for generating an output based on the one or more first tensors and the one or more second tensors.

Aspects generally include a method, apparatus, system, computer program product, non-transitory computer-readable medium, user device, user equipment, wireless communication device, and/or processing system as substantially described with reference to and as illustrated by the drawings and specification.

In some aspects, one or more of the apparatuses described herein is, is part of, or includes a vehicle (e.g., an automobile, truck, etc., or a component or system of an automobile, truck, etc.), a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, a robotics device, or other device. In some aspects, the apparatus includes radio detection and ranging (radar) for capturing radio frequency (RF) signals. In some aspects, the apparatus includes one or more light detection and ranging (LIDAR) sensors, radar sensors, or other light-based sensors for capturing light-based (e.g., optical frequency) signals. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors, which can be used for determining a location of the apparatuses, a state of the apparatuses (e.g., a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended for use in isolation to determine the scope of the claimed subject matter. The subject matter should be understood by reference to appropriate portions of the entire specification of this patent, any or all drawings, and each claim.

Other objects and advantages associated with the aspects disclosed herein will be apparent to those skilled in the art based on the accompanying drawings and detailed description.

### BRIEF DESCRIPTION OF THE DRAWINGS

Illustrative aspects of the present application are described in detail below with reference to the following figures:

FIG. 1 is a diagram illustrating an example wireless communications system, in accordance with some aspects of the present disclosure.

FIG. 2 is a diagram illustrating an example of a disaggregated base station architecture, which may be employed by the disclosed system for sidelink positioning with UE session participation criteria and thresholds, in accordance with some aspects of the present disclosure.

FIG. 3 is a diagram illustrating an example of various user equipment (UEs) communicating over direct communication interfaces (e.g., a cellular based PC5 sidelink interface, 802.11p defined dedicated short-range communications (DSRC) interface, or other direct interface) and wide area network (Uu) interfaces, in accordance with some aspects of the present disclosure.

FIG. 4 is a block diagram illustrating an example of a computing system of a vehicle, in accordance with some aspects of the present disclosure.

FIG. 5 is a diagram illustrating an example of a system for sensor sharing in wireless communications (e.g., V2X communications), in accordance with some aspects of the present disclosure.

FIG. 6 is a diagram illustrating an example showing a vehicle with a blocked view of an oncoming object, in accordance with some aspects of the present disclosure.

FIG. 7 is a diagram illustrating an example of views of sensors associated with a vehicle, in accordance with some aspects of the present disclosure.

FIG. 8 is a diagram illustrating an example of a system for obtaining encoder tensors and projecting the encoder tensors onto a top view representation of a vehicle, in accordance with some aspects of the present disclosure.

FIG. 9 is a diagram illustrating an example of generating a three-dimensional (3D) tensor representation of sensor data, which may be in the form of an image, in accordance with some aspects of the present disclosure.

FIG. 10 is a diagram illustrating an example of projecting an image plane of the 3D tensor representation onto a top view representation of a vehicle, in accordance with some aspects of the present disclosure.

FIG. 11 is a diagram illustrating an example of a top view representation of a vehicle with an overlap region, in accordance with some aspects of the present disclosure.

FIG. 12 is a diagram illustrating an example of a system for inter-vehicle low-level fusion tensor transfer, in accordance with some aspects of the present disclosure.

FIG. 13 is a diagram illustrating an example of a top view representation of a vehicle with an object located out of range of the view, in accordance with some aspects of the present disclosure.

FIG. 14 is a diagram illustrating an example showing a vehicle, with a blocked view of a region of interest, sending requests to other nearby vehicles for information associated with the region of interest, in accordance with some aspects of the present disclosure.

FIG. 15 is a signaling diagram illustrating an example of communications for a vehicle requesting nearby vehicles for information associated with a region of interest, in accordance with some aspects of the present disclosure.

FIG. 16 is a diagram illustrating an example of identification, verification, and connection to a vehicle, in accordance with some aspects of the present disclosure.

FIG. 17 is a signaling diagram illustrating an example of communications for identification and verification of a vehicle, where a visual identity of the vehicle is first established, in accordance with some aspects of the present disclosure.

FIG. 18 is a signaling diagram illustrating an example of communications for identification and verification of a vehicle, where an electronic identity of the vehicle is first established, in accordance with some aspects of the present disclosure.

FIG. 19 is a diagram illustrating an example showing a vehicle, with a blocked view of an oncoming vehicle, receiving information from a stationary remote sensor, in accordance with some aspects of the present disclosure.

FIG. 20 is a diagram illustrating an example of a top view representation of a vehicle with an object located out of range of the view, where data collection for the object is triggered, in accordance with some aspects of the present disclosure.

FIG. 21 is a flow diagram illustrating an example of a process for vehicle communications, in accordance with some aspects of the disclosure.

FIG. 22 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Wireless communications systems are deployed to provide various telecommunication services, including telephony, video, data, messaging, broadcasts, among others. Wireless communications systems have developed through various generations. A fifth generation (5G) mobile standard calls for higher data transfer speeds, greater numbers of connections, and better coverage, among other improvements. The 5G standard (also referred to as “New Radio” or “NR”), according to the Next Generation Mobile Networks Alliance, is designed to provide data rates of several tens of megabits per second to each of tens of thousands of users.

Vehicles are an example of systems that can include wireless communications capabilities. For example, vehicles (e.g., automotive vehicles, autonomous vehicles, aircraft, maritime vessels, among others) can communicate with other vehicles and/or with other devices that have wireless communications capabilities. Wireless vehicle communication systems can be performed using peer-to-peer communications. Peer-to-peer communications can be performed using vehicle-to-everything (V2X) technology. V2X communications is a vehicular communication system that supports wireless transfer of information to/from a vehicle from/to other entities (e.g., other vehicles, pedestrians with smart phones, equipped vulnerable road users (VRUs), such as bicyclists, and/or other traffic infrastructure) located within a traffic system that may affect the vehicle.

V2X communications encompass vehicle-to-vehicle (V2V), vehicle-to-infrastructure (V2I), vehicle-to-network (V2N), vehicle-to-pedestrian (V2P), and vehicle-to-grid (V2G) communications (e.g., data going to the electric grid, such as for the purpose of actively managing energy in electric vehicles or other electric devices or systems). For example, V2V communications allows for a vehicle to wirelessly communicate directly with one or more other vehicles. V2X technology can be used to improve road safety, fuel savings, traffic efficiency, among others. For example, with V2X communications, vehicles can gain situational awareness by receiving information regarding upcoming road dangers (e.g., unforeseen oncoming vehicles, accidents, and road conditions) from the other vehicles.

In a V2X communication system, information is transmitted from vehicle sensors (and other sources) through wireless links to allow the information to be communicated to other vehicles, pedestrians, VRUs, traffic infrastructure, and/or other V2X-enabled devices. The information may be transmitted using one or more vehicle-based messages, such as cellular-vehicle-to-everything (C-V2X) messages, which can include Sensor Data Sharing Messages (SDSMs), Basic Safety Messages (BSMs), Cooperative Awareness Messages (CAMs), Collective Perception Messages (CPMs), Decentralized Environmental Messages (DENMs), and/or other types of vehicle-based messages. By sharing this information with other vehicles, the other vehicle (and driver) can be made aware of potential dangers to help reduce collisions with other vehicles and entities. In addition, the V2X technology enhances traffic efficiency by providing traffic warnings to vehicles of potential upcoming road dangers and obstacles such that vehicles may choose alternative traffic routes.

V2X wireless communications can be performed using a C-V2X interface, a dedicated short-range communications (DSRC) interface defined by the IEEE 802.11p Standard, and/or other wireless peer-to-peer communications technology. Characteristics of the IEEE 802.11p based DSRC interface include low latency and the use of the unlicensed 5.9 Gigahertz (GHz) frequency band. C-V2X was adopted as an alternative to using the IEEE 802.11p based DSRC interface for the wireless communications. The 5G Automotive Association (5GAA) supports the use of C-V2X technology. In some cases, the C-V2X technology uses Long-Term Evolution (LTE) as the underlying technology, and the C-V2X functionalities are based on the LTE technology. In other cases, C-V2X can be performed using fifth generation (5G)/New Radio (NR) technology, sixth generation (6G) wireless technology, or other cellular technology.

C-V2X includes a plurality of operational modes. One of the operational modes allows for direct wireless communication between vehicles over the LTE sidelink PC5 interface. Similar to the IEEE 802.11p based DSRC interface, the LTE C-V2X sidelink PC5 interface operates over the 5.9 GHz frequency band. Vehicle-based messages, such as BSMs and CAMs, which are application layer messages, are designed to be wirelessly broadcasted over the 802.11p based DSRC interface and the LTE C-V2X sidelink PC5 interface.

Currently, vehicles (e.g., autonomous driving (AD) vehicles, semi-autonomous driving vehicles, etc.) and systems of the vehicles (e.g., advanced driver assistance systems (ADAS)) are generally based on a model of a real-world environment. For example, sensors of a vehicle (e.g., cameras, radar sensors, light-detection and ranging (LIDAR) sensors, etc.) can capture sensor data representing a real-world environment surrounding the vehicle. The vehicle can process the sensor data to generate a model of the real-world environment. The model of the real-world environment can be used to make driving decisions, such as output lane-departure warnings, perform lane-assist operations, perform autonomous driving maneuvers, etc.

Because vehicles (e.g., ego vehicles) model the real-world environments based on their own sensor data, the vehicles (e.g., ego vehicles) are unable to perceive what other vehicles (e.g., remove vehicles) detect. For example, even if remote vehicles can perceive relevant or interesting objects (e.g., which are obscured in the views of an ego vehicle), information associated with these detected objects cannot be utilized by the ego vehicle unless this information is transferred to the ego vehicle from the remove vehicles. In some cases, this type of information can be exchanged amongst vehicles, such as by using vehicle-based messages (e.g., C-V2X messages) to exchange sensor data. However, these solutions do not involve building a real-world model from the perspective of the ego vehicles by using low-level fusion (e.g., fusion of latent features generated by a machine-learning model, such as features stored in a tensor or other feature representation).

In one or more aspects of the present disclosure, systems, apparatuses, methods (also referred to as processes), and computer-readable media (collectively referred to herein as “systems and techniques”) are described herein that provide solutions for inter-vehicle low-level fusion feature representation (e.g., tensor) transfer. While tensors are used herein as an example of feature representations, other types of feature representations may be used, such as vector representations, matrix representations, and/or other feature representation.

Various aspects relate generally to vehicle communications. Some aspects more specifically relate to systems and techniques that provide solutions that transfer low-level fusion “encoder tensors” (or other feature representation) between vehicles. The encoder tensors can be generated by a neural network encoder of a neural network system of the vehicle. The encoder tensors can include latent features that represent sensor data captured by the vehicles. In some cases, the low-level fusion encoder tensors can be transferred or exchanged from one or more remote vehicles to an ego vehicle, such that a local (e.g., ego vehicle) view transform of the ego vehicle can insert the tensors (e.g., associated with a remote vehicle view) into a local top-view (e.g., a bird's eye view) representation along with information from the local sensors. The insertion of these tensors can allow for an improvement in the detection range accuracy (e.g., of the ego vehicle) and/or an improvement in the ego vehicle view, which may include obscured portions due to one or more factors. For example, a region or object in a scene may be obscured in sensor data of a sensor of the ego vehicle based on a view of the sensor being obstructed or blocked (e.g., blocked by an object in the scene, blocked based on placement of the sensor on the vehicle relative to the region or object, etc.), the sensor being placed on the vehicle (e.g., with a fixed placement) such that the sensor is incapable of obtaining sensor measurements of the region or object, the sensor being broken, the sensor being dirty, the sensor being blinded by low sun or oncoming headlights, the first sensor (e.g., a radar or LIDAR sensor) experiencing interference from other active sensors from other vehicles or road-side installations (e.g., roadside units (RSUs)), any combination thereof, and/or other factor(s) affecting the view of the sensor.

In one or more examples, the systems and techniques involve one or more remote vehicles extracting a tensor (e.g., output by an encoder of a neural network system of the remote vehicle(s)), the remote vehicle(s) wirelessly transmitting the tensor to a local vehicle (e.g., an ego vehicle), and the local vehicle providing the tensor to a local view transform. In some examples, the tensor may be run (e.g., by the local vehicle) through a local re-coder. The local re-coder of the local vehicle can adapt the tensor to the local vehicle system, before inputting the tensor into the local view transform. When employing the systems and techniques, the local vehicle (e.g., ego vehicles) can, in an effective manner, utilize and insert information (e.g., tensors) obtained from other vehicles (e.g., remote vehicles) into their local top view representations. The systems and techniques (e.g., by inserting the tensors in the local top view representations) can enable the detection (e.g., by the local vehicle) of regions (e.g., including objects and features) that are located outside of the range of local sensors, enable the detection of objects obscured in views of the local sensors, provide a second viewpoint (e.g., a viewpoint of a remote vehicle) of a region (e.g., including an object) that is not obscured or blocked (e.g., within the view of the local vehicle) by oncoming headlights of other vehicles or by confusing radar echoes. As noted previously, a region in an environment (e.g., including one or more objects) can be obscured in a view of a local sensor due to one or more factors, such as based on a view of the sensor being obstructed or blocked, the sensor being broken, the sensor being dirty, the sensor being blinded by low sun or oncoming headlights, the first sensor (e.g., a radar or LIDAR sensor) experiencing interference from other active sensors from other vehicles or road-side installations (e.g., roadside units (RSUs)), any combination thereof, and/or other factor(s) affecting the view of the local sensor. As such, the systems and techniques can enhance the confidence (e.g., of a local vehicle, such as an ego vehicle) of detected objects or features (e.g., of the objects), position, velocity, and/or other meta data of the objects and/or features.

In one or more aspects, during operation for vehicle communications at a first vehicle, one or more first sensors of the vehicle can obtain first sensor data. One or more encoders (e.g., one or more perspective view encoders) of the first vehicle can generate or produce, based on the first sensor data, one or more first tensors (or other feature representation). The one or more encoders can be part of a machine learning system (e.g., a neural network model or system) of the first vehicle. The first vehicle can obtain (e.g., receive) one or more second tensors that are from the second vehicle. The one or more second tensors can be associated with second sensor data obtained from one or more second sensors of the second vehicle. The second sensor data can include information associated with one or more regions (e.g. which may include one or more objects) obscured within the first sensor data (e.g., based on a view of the one or more first sensors being obstructed or blocked, the one or more first sensors being broken, the one or more first sensors being dirty, the one or more first sensors being blinded by low sun or oncoming headlights, the one or more first sensors (e.g., a radar or LIDAR sensor) experiencing interference from other active sensors from other vehicles or road-side devise or systems (e.g., RSUs), any combination thereof, and/or other factor(s) affecting the view of the one or more first sensors). In some examples, each tensor of the one or more first tensors and each tensor of the one or more second tensors represents a perspective view of an environment of the first vehicle. For instance, each tensor of the one or more first tensors and each tensor of the one or more second tensors can be a respective perspective view encoder output tensor. In some cases, each sensor of the one or more first sensors and each sensor of the one or more second sensors can be a respective image sensor, a respective radar sensor, or a respective LIDAR sensor. In one or more examples, the third tensor can be a bird's eye view (BEV) tensor. In some examples, the first vehicle can be an ego vehicle.

The first vehicle can generate an output based on the one or more first tensors and the one or more second tensors. For instance, the first vehicle can fuse the one or more first tensors and the one or more second tensors to generate or produce a third tensor. For example, a view transform of the first vehicle can project the one or more first tensors and the one or more second tensors onto a top view representation of the first vehicle to generate the third tensor. One or more processors of the first vehicle can process the third tensor to generate an output. For example, the one or more processors can detect, based on the third tensor, one or more objects (e.g., in the one or more regions) to generate an object detection output. For example, to process the third tensor, the one or more processors can detect, based on the third tensor, the one or more objects. In some cases, to process the third tensor, BEV encoders and decoders of the first vehicle can generate or produce, based on the third tensor, one or more output tensors representing the object detection output. In one or more examples, each output tensor of the one or more output tensors can represent at least one property of the one or more objects. For instance, the at least one property can include a respective probability of each object being located at a respective location within an environment of the first vehicle, a respective orientation of each object, a respective class of each object, a respective size of each object, a respective velocity of each object, any combination thereof, and/or other properties.

In one or more examples, the one or more processors of the first vehicle can determine a region of interest based on a view of at least one first sensor of the one or more first sensors. For instance, the view can be affected in a way that the first vehicle determines to request supplemental information from the second vehicle for the region of interest. In some examples, the view of the at least one first sensor being obscured (e.g., obstructed or blocked), the first sensor being broken, dirty, blinded by low sun or oncoming headlights, the first sensor (e.g., a radar or LIDAR sensor) experiencing interference from other active sensors from other vehicles or road-side installations (e.g., RSUs), any combination thereof, and/or other factors affecting the view of the at least one first sensor. In some examples, the confidence estimated by the first vehicle is insufficient for a certain decision, in which case the first vehicle can request information from the second vehicle for a “second opinion” for the decision. In some examples, the first vehicle can transmit to the second vehicle a request for a sensor listing including the one or more second sensors with a view of the region of interest. The first vehicle can receive from the second vehicle the sensor listing. The first vehicle can transmit to the second vehicle, based on the sensor listing, a request to subscribe to the one or more second sensors in the sensor listing. The first vehicle can transmit to a remote cloud server a request for a vehicle listing including vehicles with sensors having views of the region of interest, where the vehicle listing includes the second vehicle. The first vehicle can transmit to the second vehicle a request for information associated with the second vehicle. The first vehicle can receive from the second vehicle, based on transmitting the request, the information. The first vehicle can establish, based on the information, direct communications with the second vehicle. The information can include a license plate number of the second vehicle, a color of the second vehicle, a position of the second vehicle, a make of the second vehicle, a model of the second vehicle, and/or a physical identification (ID) of the second vehicle. The first vehicle can receive, from vehicles within a fleet of vehicles including the second vehicle, one or more fourth tensors associated with third sensor data. The third sensor data can be associated with the one or more regions obscured within the first sensor data.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

In some cases, a network entity can be implemented in an aggregated or monolithic base station or server architecture, or alternatively, in a disaggregated base station or server architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In some cases, a network entity can include a server device, such as a Multi-access Edge Compute (MEC) device. A base station or server (e.g., with an aggregated/monolithic base station architecture or disaggregated base station architecture) may operate according to one of several RATs in communication with UEs, roadside units (RSUs), and/or other devices depending on the network in which it is deployed, and may be alternatively referred to as an access point (AP), a network node, a NodeB (NB), an evolved NodeB (CNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical TRP or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

A roadside unit (RSU) is a device that can transmit and receive messages over a communications link or interface (e.g., a cellular-based sidelink or PC5 interface, an 802.11 or WiFi™ based Dedicated Short Range Communication (DSRC) interface, and/or other interface) to and from one or more UEs, other RSUs, and/or base stations. An example of messages that can be transmitted and received by an RSU includes vehicle-to-everything (V2X) messages, which are described in more detail below. RSUs can be located on various transportation infrastructure systems, including roads, bridges, parking lots, toll booths, and/or other infrastructure systems. In some examples, an RSU can facilitate communication between UEs (e.g., vehicles, pedestrian user devices, and/or other UEs) and the transportation infrastructure systems. In some implementations, a RSU can be in communication with a server, base station, and/or other system that can perform centralized management functions.

An RSU can communicate with a communications system of a UE. For example, an intelligent transport system (ITS) of a UE (e.g., a vehicle and/or other UE) can be used to generate and sign messages for transmission to an RSU and to validate messages received from an RSU. An RSU can communicate (e.g., over a PC5 interface, DSRC interface, etc.) with vehicles traveling along a road, bridge, or other infrastructure system in order to obtain traffic-related data (e.g., time, speed, location, etc. of the vehicle). In some cases, in response to obtaining the traffic-related data, the RSU can determine or estimate traffic congestion information (e.g., a start of traffic congestion, an end of traffic congestion, etc.), a travel time, and/or other information for a particular location. In some examples, the RSU can communicate with other RSUs (e.g., over a PC5 interface, DSRC interface, etc.) in order to determine the traffic-related data. The RSU can transmit the information (e.g., traffic congestion information, travel time information, and/or other information) to other vehicles, pedestrian UEs, and/or other UEs. For example, the RSU can broadcast or otherwise transmit the information to any UE (e.g., vehicle, pedestrian UE, etc.) that is in a coverage range of the RSU.

A radio frequency signal or “RF signal” includes an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

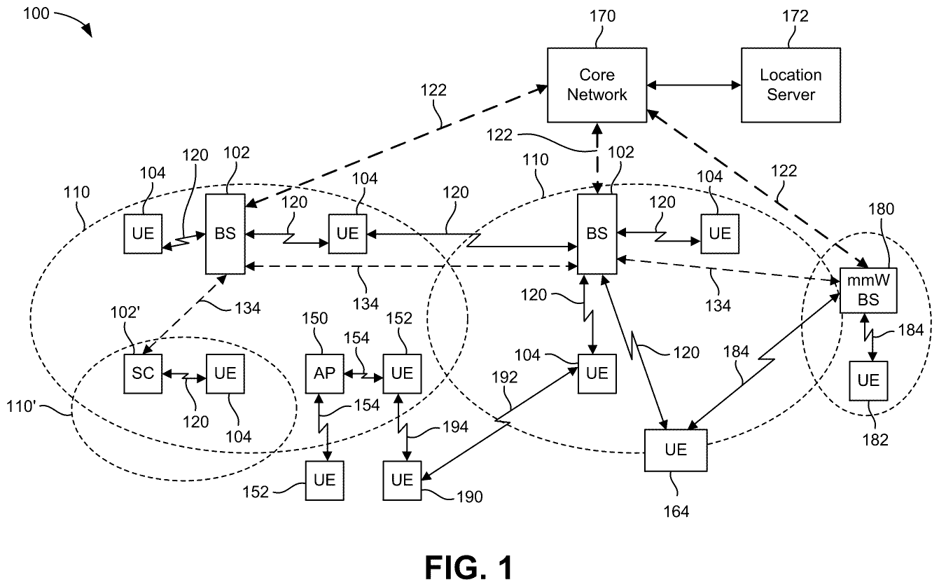

According to various aspects, FIG. 1 illustrates an exemplary wireless communications system 100. The wireless communications system 100 (which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc. utilizing the ultra-wideband (UWB) spectrum. The UWB spectrum can range from 3.1 to 10.5 GHZ.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHZ and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node or entity (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receiving beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain of other beams available to the receiver. This results in a stronger received signal strength, (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a network node or entity (e.g., a base station). The UE can then form a transmit beam for sending one or more uplink reference signals (e.g., uplink positioning reference signals (UL-PRS), sounding reference signal (SRS), demodulation reference signals (DMRS), PTRS, etc.) to that network node or entity (e.g., a base station) based on the parameters of the receive beam.

Note that a “downlink” beam may be either a transmit beam or a receive beam, depending on the entity forming it. For example, if a network node or entity (e.g., a base station) is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a network node or entity (e.g., a base station) is forming the uplink beam, it is an uplink receive beam, and if a UE is forming the uplink beam, it is an uplink transmit beam.

In 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 is equipped with multiple receivers and/or transmitters. For example, a UE 104 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

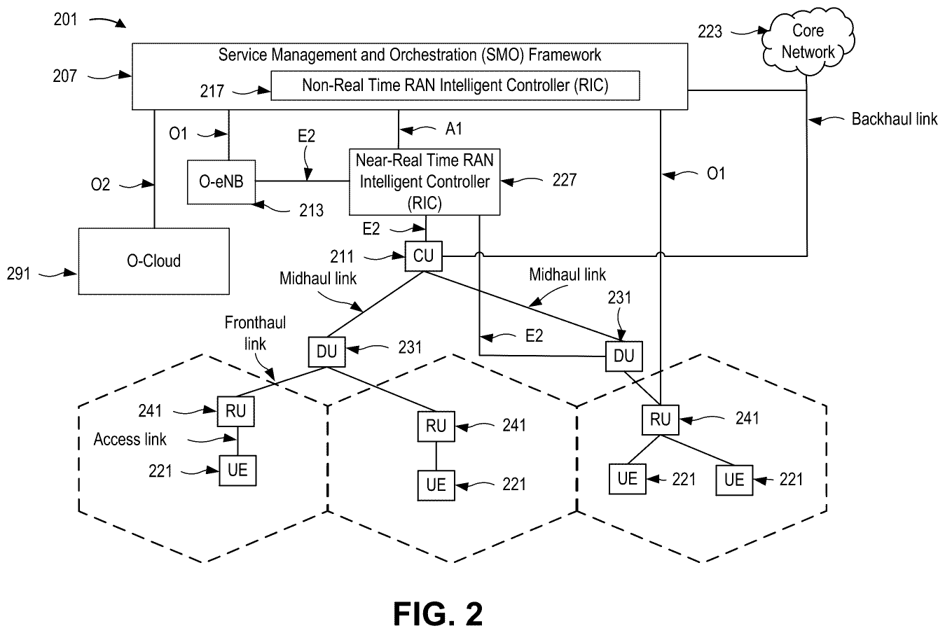

FIG. 2 is a diagram illustrating an example of a disaggregated base station architecture, which may be employed by the disclosed system for inter-vehicle low-level fusion tensor transfer. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, AP, a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

As previously mentioned, FIG. 2 shows a diagram illustrating an example disaggregated base station 201 architecture. The disaggregated base station 201 architecture may include one or more central units (CUs) 211 that can communicate directly with a core network 223 via a backhaul link, or indirectly with the core network 223 through one or more disaggregated base station units (such as a Near-Real Time (Near-RT) RAN Intelligent Controller (RIC) 227 via an E2 link, or a Non-Real Time (Non-RT) RIC 217 associated with a Service Management and Orchestration (SMO) Framework 207, or both). A CU 211 may communicate with one or more distributed units (DUs) 231 via respective midhaul links, such as an F1 interface. The DUs 231 may communicate with one or more radio units (RUS) 241 via respective fronthaul links. The RUs 241 may communicate with respective UEs 221 via one or more RF access links. In some implementations, the UE 221 may be simultaneously served by multiple RUs 241.

Each of the units, i.e., the CUS 211, the DUs 231, the RUs 241, as well as the Near-RT RICs 227, the Non-RT RICs 217 and the SMO Framework 207, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 211 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 211. The CU 211 may be configured to handle user plane functionality (i.e., Central Unit-User Plane (CU-UP)), control plane functionality (i.e., Central Unit-Control Plane (CU-CP)), or a combination thereof. In some implementations, the CU 211 can be logically split into one or more CU-UP units and one or more CU-CP units. The CU-UP unit can communicate bidirectionally with the CU-CP unit via an interface, such as the E1 interface when implemented in an O-RAN configuration. The CU 211 can be implemented to communicate with the DU 131, as necessary, for network control and signaling.

The DU 231 may correspond to a logical unit that includes one or more base station functions to control the operation of one or more RUs 241. In some aspects, the DU 231 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 231 may further host one or more low PHY layers. Each layer (or module) can be implemented with an interface configured to communicate signals with other layers (and modules) hosted by the DU 231, or with the control functions hosted by the CU 211.

Lower-layer functionality can be implemented by one or more RUs 241. In some deployments, an RU 241, controlled by a DU 231, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 241 can be implemented to handle over the air (OTA) communication with one or more UEs 221. In some implementations, real-time and non-real-time aspects of control and user plane communication with the RU(s) 241 can be controlled by the corresponding DU 231. In some scenarios, this configuration can enable the DU(s) 231 and the CU 211 to be implemented in a cloud-based RAN architecture, such as a vRAN architecture.

The SMO Framework 207 may be configured to support RAN deployment and provisioning of non-virtualized and virtualized network elements. For non-virtualized network elements, the SMO Framework 207 may be configured to support the deployment of dedicated physical resources for RAN coverage requirements which may be managed via an operations and maintenance interface (such as an O1 interface). For virtualized network elements, the SMO Framework 207 may be configured to interact with a cloud computing platform (such as an open cloud (O-Cloud) 291) to perform network element life cycle management (such as to instantiate virtualized network elements) via a cloud computing platform interface (such as an O2 interface). Such virtualized network elements can include, but are not limited to, CUs 211, DUs 231, RUs 241 and Near-RT RICs 227. In some implementations, the SMO Framework 207 can communicate with a hardware aspect of a 4G RAN, such as an open eNB (O-cNB) 213, via an O1 interface. Additionally, in some implementations, the SMO Framework 207 can communicate directly with one or more RUs 241 via an O1 interface. The SMO Framework 207 also may include a Non-RT RIC 217 configured to support functionality of the SMO Framework 207.

The Non-RT RIC 217 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 227. The Non-RT RIC 217 may be coupled to or communicate with (such as via an A1 interface) the Near-RT RIC 227. The Near-RT RIC 227 may be configured to include a logical function that enables near-real-time control and optimization of RAN elements and resources via data collection and actions over an interface (such as via an E2 interface) connecting one or more CUs 211, one or more DUs 231, or both, as well as an O-eNB 213, with the Near-RT RIC 227.

In some implementations, to generate AI/ML models to be deployed in the Near-RT RIC 227, the Non-RT RIC 217 may receive parameters or external enrichment information from external servers. Such information may be utilized by the Near-RT RIC 227 and may be received at the SMO Framework 207 or the Non-RT RIC 217 from non-network data sources or from network functions. In some examples, the Non-RT RIC 217 or the Near-RT RIC 227 may be configured to tune RAN behavior or performance. For example, the Non-RT RIC 217 may monitor long-term trends and patterns for performance and employ AI/ML models to perform corrective actions through the SMO Framework 207 (such as reconfiguration via 01) or via creation of RAN management policies (such as A1 policies).

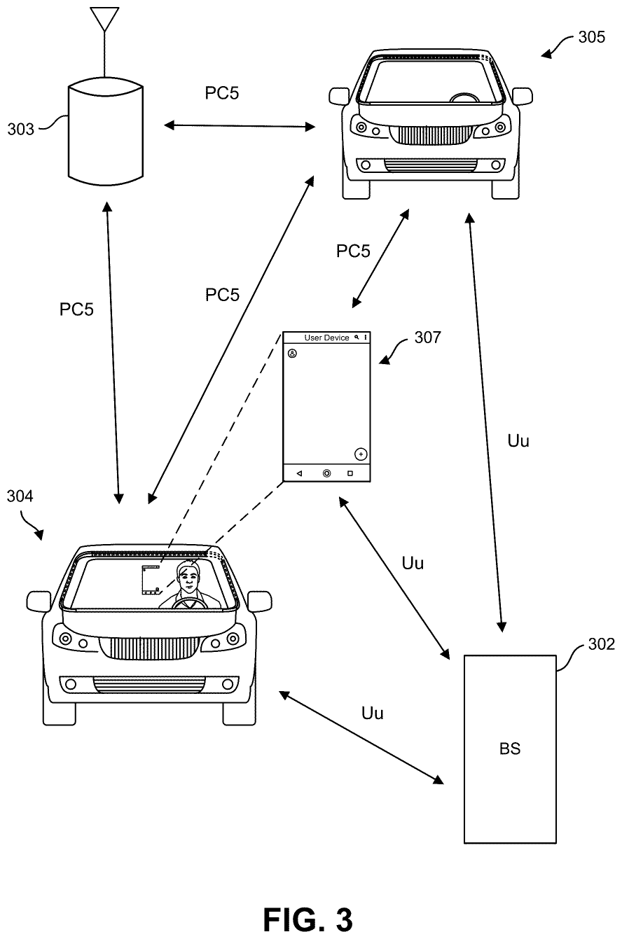

FIG. 3 illustrates examples of different communication mechanisms used by various UEs. In one example of sidelink communications, FIG. 3 illustrates a vehicle 304, a vehicle 305, and an RSU 303 communicating with each other using PC5, DSRC, or other device to device direct signaling interfaces. In addition, the vehicle 304 and the vehicle 305 may communicate with a base station 302 (shown as BS 302) using a network (Uu) interface. The base station 302 can include a gNB in some examples. FIG. 3 also illustrates a user device 307 communicating with the base station 302 using a network (Uu) interface. As described below, functionalities can be transferred from a vehicle (e.g., vehicle 304) to a user device (e.g., user device 307) based on one or more characteristics or factors (e.g., temperature, humidity, etc.). In one illustrative example, V2X functionality can be transitioned from the vehicle 304 to the user device 307, after which the user device 307 can communicate with other vehicles (e.g., vehicle 305) over a PC5 interface (or other device to device direct interface, such as a DSRC interface), as shown in FIG. 3.

While FIG. 3 illustrates a particular number of vehicles (e.g., two vehicles 304 and 305) communicating with each other and/or with RSU 303, BS 302, and/or user device 307, the present disclosure is not limited thereto. For instance, tens or hundreds of such vehicles may be communicating with one another and/or with RSU 303, BS 302, and/or user device 307. At any given point in time, each such vehicle, RSU 303, BS 302, and/or user device 307 may transmit various types of information as messages to other nearby vehicles resulting in each vehicle (e.g., vehicles 304 and/or 305), RSU 303, BS 302, and/or user device 307 receiving hundreds or thousands of messages from other nearby vehicles, RSUs, base stations, and/or other UEs per second.

While PC5 interfaces are shown in FIG. 3, the various UEs (e.g., vehicles, user devices, etc.) and RSU(s) can communicate directly using any suitable type of direct interface, such as an 802.11 DSRC interface, a Bluetooth™ interface, and/or other interface. For example, a vehicle can communicate with a user device over a direct communications interface (e.g., using PC5 and/or DSRC), a vehicle can communicate with another vehicle over the direct communications interface, a user device can communicate with another user device over the direct communications interface, a UE (e.g., a vehicle, user device, etc.) can communicate with an RSU over the direct communications interface, an RSU can communicate with another RSU over the direct communications interface, and the like.

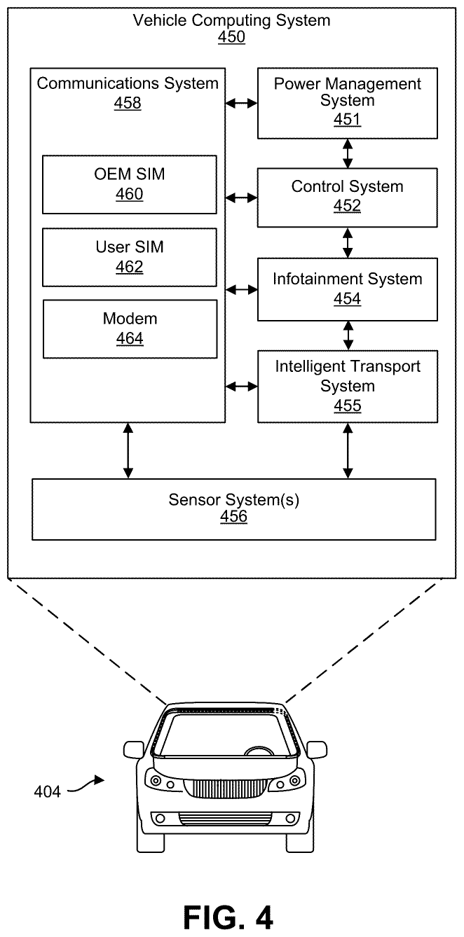

FIG. 4 is a block diagram illustrating an example a vehicle computing system 450 of a vehicle 404. The vehicle 404 is an example of a UE that can communicate with a network (e.g., an cNB, a gNB, a positioning beacon, a location measurement unit, and/or other network entity) over a Uu interface and with other UEs using V2X communications over a PC5 interface (or other device to device direct interface, such as a DSRC interface). As shown, the vehicle computing system 450 can include at least a power management system 451, a control system 452, an infotainment system 454, an intelligent transport system (ITS) 455, one or more sensor systems 456, and a communications system 458. In some cases, the vehicle computing system 450 can include or can be implemented using any type of processing device or system, such as one or more central processing units (CPUs), digital signal processors (DSPs), application specific integrated circuits (ASICs), field programmable gate arrays (FPGAs), application processors (APs), graphics processing units (GPUs), vision processing units (VPUs), Neural Network Signal Processors (NSPs), microcontrollers, dedicated hardware, any combination thereof, and/or other processing device or system.

The control system 452 can be configured to control one or more operations of the vehicle 404, the power management system 451, the computing system 450, the infotainment system 454, the ITS 455, and/or one or more other systems of the vehicle 404 (e.g., a braking system, a steering system, a safety system other than the ITS 455, a cabin system, and/or other system). In some examples, the control system 452 can include one or more electronic control units (ECUs). An ECU can control one or more of the electrical systems or subsystems in a vehicle. Examples of specific ECUs that can be included as part of the control system 452 include an engine control module (ECM), a powertrain control module (PCM), a transmission control module (TCM), a brake control module (BCM), a central control module (CCM), a central timing module (CTM), among others. In some cases, the control system 452 can receive sensor signals from the one or more sensor systems 456 and can communicate with other systems of the vehicle computing system 450 to operate the vehicle 404.

The vehicle computing system 450 also includes a power management system 451. In some implementations, the power management system 451 can include a power management integrated circuit (PMIC), a standby battery, and/or other components. In some cases, other systems of the vehicle computing system 450 can include one or more PMICs, batteries, and/or other components. The power management system 451 can perform power management functions for the vehicle 404, such as managing a power supply for the computing system 450 and/or other parts of the vehicle. For example, the power management system 451 can provide a stable power supply in view of power fluctuations, such as based on starting an engine of the vehicle. In another example, the power management system 451 can perform thermal monitoring operations, such as by checking ambient and/or transistor junction temperatures. In another example, the power management system 451 can perform certain functions based on detecting a certain temperature level, such as causing a cooling system (e.g., one or more fans, an air conditioning system, etc.) to cool certain components of the vehicle computing system 450 (e.g., the control system 452, such as one or more ECUs), shutting down certain functionalities of the vehicle computing system 450 (e.g., limiting the infotainment system 454, such as by shutting off one or more displays, disconnecting from a wireless network, etc.), among other functions.

The vehicle computing system 450 further includes a communications system 458. The communications system 458 can include both software and hardware components for transmitting signals to and receiving signals from a network (e.g., a gNB or other network entity over a Uu interface) and/or from other UEs (e.g., to another vehicle or UE over a PC5 interface, WiFi interface (e.g., DSRC), Bluetooth™ interface, and/or other wireless and/or wired interface). For example, the communications system 458 is configured to transmit and receive information wirelessly over any suitable wireless network (e.g., a 3G network, 4G network, 5G network, WiFi network, Bluetooth™ network, and/or other network). The communications system 458 includes various components or devices used to perform the wireless communication functionalities, including an original equipment manufacturer (OEM) subscriber identity module (referred to as a SIM or SIM card) 460, a user SIM 462, and a modem 464. The SIM 460 can include a hardware SIM, a software-based SIM (or eSIM) (e.g., a programmable SIM card), any combination thereof, and/or other types of SIMs. While the vehicle computing system 450 is shown as having two SIMs and one modem, the computing system 450 can have any number of SIMs (e.g., one SIM or more than two SIMs) and any number of modems (e.g., one modem, two modems, or more than two modems) in some implementations.

A SIM is a device (e.g., an integrated circuit) that can securely store an international mobile subscriber identity (IMSI) number and a related key (e.g., an encryption-decryption key) of a particular subscriber or user. The IMSI and key can be used to identify and authenticate the subscriber on a particular UE. The OEM SIM 460 can be used by the communications system 458 for establishing a wireless connection for vehicle-based operations, such as for conducting emergency-calling (eCall) functions, communicating with a communications system of the vehicle manufacturer (e.g., for software updates, etc.), among other operations. The OEM SIM 460 can be important for the OEM SIM to support critical services, such as eCall for making emergency calls in the event of a car accident or other emergency. For instance, eCall can include a service that automatically dials an emergency number (e.g., “9-1-1” in the United States, “1-1-2” in Europe, etc.) in the event of a vehicle accident and communicates a location of the vehicle to the emergency services, such as a police department, fire department, etc.

The user SIM 462 can be used by the communications system 458 for performing wireless network access functions in order to support a user data connection (e.g., for conducting phone calls, messaging, Infotainment related services, among others). In some cases, a user device of a user can connect with the vehicle computing system 450 over an interface (e.g., over PC5, Bluetooth™, WiFI™ (e.g., DSRC), a universal serial bus (USB) port, and/or other wireless or wired interface). Once connected, the user device can transfer wireless network access functionality from the user device to communications system 458 the vehicle, in which case the user device can cease performance of the wireless network access functionality (e.g., during the period in which the communications system 458 is performing the wireless access functionality). The communications system 458 can begin interacting with a base station to perform one or more wireless communication operations, such as facilitating a phone call, transmitting and/or receiving data (e.g., messaging, video, audio, etc.), among other operations. In such cases, other components of the vehicle computing system 450 can be used to output data received by the communications system 458. For example, the infotainment system 454 (described below) can display video received by the communications system 458 on one or more displays and/or can output audio received by the communications system 458 using one or more speakers.

A modem is a device that modulates one or more carrier wave signals to encode digital information for transmission, and demodulates signals to decode the transmitted information. The modem 464 (and/or one or more other modems of the communications system 458) can be used for communication of data for the OEM SIM 460 and/or the user SIM 462. In some examples, the modem 464 can include a 4G (or LTE) modem and another modem (not shown) of the communications system 458 can include a 5G (or NR) modem. In some examples, the communications system 458 can include one or more Bluetooth™ modems (e.g., for Bluetooth™ Low Energy (BLE) or other type of Bluetooth communications), one or more WiFi™ modems (e.g., for DSRC communications and/or other WiFi communications), wideband modems (e.g., an ultra-wideband (UWB) modem), any combination thereof, and/or other types of modems.

In some cases, the modem 464 (and/or one or more other modems of the communications system 458) can be used for performing V2X communications (e.g., with other vehicles for V2V communications, with other devices for D2D communications, with infrastructure systems for V2I communications, with pedestrian UEs for V2P communications, etc.). In some examples, the communications system 458 can include a V2X modem used for performing V2X communications (e.g., sidelink communications over a PC5 interface or DSRC interface), in which case the V2X modem can be separate from one or more modems used for wireless network access functions (e.g., for network communications over a network/Uu interface and/or sidelink communications other than V2X communications).

In some examples, the communications system 458 can be or can include a telematics control unit (TCU). In some implementations, the TCU can include a network access device (NAD) (also referred to in some cases as a network control unit or NCU). The NAD can include the modem 464, any other modem not shown in FIG. 4, the OEM SIM 460, the user SIM 462, and/or other components used for wireless communications. In some examples, the communications system 458 can include a Global Navigation Satellite System (GNSS). In some cases, the GNSS can be part of the one or more sensor systems 456, as described below. The GNSS can provide the ability for the vehicle computing system 450 to perform one or more location services, navigation services, and/or other services that can utilize GNSS functionality.

In some cases, the communications system 458 can further include one or more wireless interfaces (e.g., including one or more transceivers and one or more baseband processors for each wireless interface) for transmitting and receiving wireless communications, one or more wired interfaces (e.g., a serial interface such as a universal serial bus (USB) input, a lightening connector, and/or other wired interface) for performing communications over one or more hardwired connections, and/or other components that can allow the vehicle 404 to communicate with a network and/or other UEs.

The vehicle computing system 450 can also include an infotainment system 454 that can control content and one or more output devices of the vehicle 404 that can be used to output the content. The infotainment system 454 can also be referred to as an in-vehicle infotainment (IVI) system or an In-car entertainment (ICE) system. The content can include navigation content, media content (e.g., video content, music or other audio content, and/or other media content), among other content. The one or more output devices can include one or more graphical user interfaces, one or more displays, one or more speakers, one or more extended reality devices (e.g., a VR, AR, and/or MR headset), one or more haptic feedback devices (e.g., one or more devices configured to vibrate a seat, steering wheel, and/or other part of the vehicle 404), and/or other output device.

In some examples, the computing system 450 can include the intelligent transport system (ITS) 455. In some examples, the ITS 455 can be used for implementing V2X communications. For example, an ITS stack of the ITS 455 can generate V2X messages based on information from an application layer of the ITS. In some cases, the application layer can determine whether certain conditions have been met for generating messages for use by the ITS 455 and/or for generating messages that are to be sent to other vehicles (for V2V communications), to pedestrian UEs (for V2P communications), and/or to infrastructure systems (for V2I communications). In some cases, the communications system 458 and/or the ITS 455 can obtain car access network (CAN) information (e.g., from other components of the vehicle via a CAN bus). In some examples, the communications system 458 (e.g., a TCU NAD) can obtain the CAN information via the CAN bus and can send the CAN information to a PHY/MAC layer of the ITS 455. The ITS 455 can provide the CAN information to the ITS stack of the ITS 455. The CAN information can include vehicle related information, such as a heading of the vehicle, speed of the vehicle, breaking information, among other information. The CAN information can be continuously or periodically (e.g., every 1 millisecond (ms), every 10 ms, or the like) provided to the ITS 455.

The conditions used to determine whether to generate messages can be determined using the CAN information based on safety-related applications and/or other applications, including applications related to road safety, traffic efficiency, infotainment, business, and/or other applications. In one illustrative example, the ITS 455 can perform lane change assistance or negotiation. For instance, using the CAN information, the ITS 455 can determine that a driver of the vehicle 404 is attempting to change lanes from a current lane to an adjacent lane (e.g., based on a blinker being activated, based on the user veering or steering into an adjacent lane, etc.). Based on determining the vehicle 404 is attempting to change lanes, the ITS 455 can determine a lane-change condition has been met that is associated with a message to be sent to other vehicles that are nearby the vehicle in the adjacent lane. The ITS 455 can trigger the ITS stack to generate one or more messages for transmission to the other vehicles, which can be used to negotiate a lane change with the other vehicles. Other examples of applications include forward collision warning, automatic emergency breaking, lane departure warning, pedestrian avoidance or protection (e.g., when a pedestrian is detected near the vehicle 404, such as based on V2P communications with a UE of the user), traffic sign recognition, among others.

The ITS 455 can use any suitable protocol to generate messages (e.g., V2X messages). Examples of protocols that can be used by the ITS 455 include one or more Society of Automotive Engineering (SAE) standards, such as SAE J2735, SAE J2945, SAE J3161, and/or other standards, which are hereby incorporated by reference in their entirety and for all purposes.

A security layer of the ITS 455 can be used to securely sign messages from the ITS stack that are sent to and verified by other UEs configured for V2X communications, such as other vehicles, pedestrian UEs, and/or infrastructure systems. The security layer can also verify messages received from such other UEs. In some implementations, the signing and verification processes can be based on a security context of the vehicle. In some examples, the security context may include one or more encryption-decryption algorithms, a public and/or private key used to generate a signature using an encryption-decryption algorithm, and/or other information. For example, each ITS message generated by the ITS 455 can be signed by the security layer of the ITS 455. The signature can be derived using a public key and an encryption-decryption algorithm. A vehicle, pedestrian UE, and/or infrastructure system receiving a signed message can verify the signature to make sure the message is from an authorized vehicle. In some examples, the one or more encryption-decryption algorithms can include one or more symmetric encryption algorithms (e.g., advanced encryption standard (AES), data encryption standard (DES), and/or other symmetric encryption algorithm), one or more asymmetric encryption algorithms using public and private keys (e.g., Rivest-Shamir-Adleman (RSA) and/or other asymmetric encryption algorithm), and/or other encryption-decryption algorithm.

In some examples, the ITS 455 can determine certain operations (e.g., V2X-based operations) to perform based on messages received from other UEs. The operations can include safety-related and/or other operations, such as operations for road safety, traffic efficiency, infotainment, business, and/or other applications. In some examples, the operations can include causing the vehicle (e.g., the control system 452) to perform automatic functions, such as automatic breaking, automatic steering (e.g., to maintain a heading in a particular lane), automatic lane change negotiation with other vehicles, among other automatic functions. In one illustrative example, a message can be received by the communications system 458 from another vehicle (e.g., over a PC5 interface, a DSRC interface, or other device to device direct interface) indicating that the other vehicle is coming to a sudden stop. In response to receiving the message, the ITS stack can generate a message or instruction and can send the message or instruction to the control system 452, which can cause the control system 452 to automatically break the vehicle 404 so that it comes to a stop before making impact with the other vehicle. In other illustrative examples, the operations can include triggering display of a message alerting a driver that another vehicle is in the lane next to the vehicle, a message alerting the driver to stop the vehicle, a message alerting the driver that a pedestrian is in an upcoming cross-walk, a message alerting the driver that a toll booth is within a certain distance (e.g., within 1 mile) of the vehicle, among others.

In some examples, the ITS 455 can receive a large number of messages from the other UEs (e.g., vehicles, RSUs, etc.), in which case the ITS 455 will authenticate (e.g., decode and decrypt) each of the messages and/or determine which operations to perform. Such a large number of messages can lead to a large computational load for the vehicle computing system 450. In some cases, the large computational load can cause a temperature of the computing system 450 to increase. Rising temperatures of the components of the computing system 450 can adversely affect the ability of the computing system 450 to process the large number of incoming messages. One or more functionalities can be transitioned from the vehicle 404 to another device (e.g., a user device, a RSU, etc.) based on a temperature of the vehicle computing system 450 (or component thereof) exceeding or approaching one or more thermal levels. Transitioning the one or more functionalities can reduce the computational load on the vehicle 404, helping to reduce the temperature of the components. A thermal load balancer can be provided that enable the vehicle computing system 450 to perform thermal based load balancing to control a processing load depending on the temperature of the computing system 450 and processing capacity of the vehicle computing system 450.

The computing system 450 further includes one or more sensor systems 456 (e.g., a first sensor system through an Nth sensor system, where N is a value equal to or greater than 0). When including multiple sensor systems, the sensor system(s) 456 can include different types of sensor systems that can be arranged on or in different parts the vehicle 404. The sensor system(s) 456 can include one or more camera sensor systems (referred to generally as cameras), LIDAR sensor systems, radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems (e.g., one or more Global Positioning System (GPS) receiver systems), accelerometers, gyroscopes, inertial measurement units (IMUs), infrared sensor systems, laser rangefinder systems, ultrasonic sensor systems, infrasonic sensor systems, microphones, any combination thereof, and/or other sensor systems. It should be understood that any number of sensors or sensor systems can be included as part of the computing system 450 of the vehicle 404.

While the vehicle computing system 450 is shown to include certain components and/or systems, one of ordinary skill will appreciate that the vehicle computing system 450 can include more or fewer components than those shown in FIG. 4. For example, the vehicle computing system 450 can also include one or more input devices and one or more output devices (not shown). In some implementations, the vehicle computing system 450 can also include (e.g., as part of or separate from the control system 452, the infotainment system 454, the communications system 458, and/or the sensor system(s) 456) at least one processor and at least one memory having computer-executable instructions that are executed by the at least one processor. The at least one processor is in communication with and/or electrically connected to (referred to as being “coupled to” or “communicatively coupled”) the at least one memory. The at least one processor can include, for example, one or more microcontrollers, one or more central processing units (CPUs), one or more field programmable gate arrays (FPGAs), one or more graphics processing units (GPUs), one or more application processors (e.g., for running or executing one or more software applications), and/or other processors. The at least one memory can include, for example, read-only memory (ROM), random access memory (RAM) (e.g., static RAM (SRAM)), electrically erasable programmable read-only memory (EEPROM), flash memory, one or more buffers, one or more databases, and/or other memory. The computer-executable instructions stored in or on the at least memory can be executed to perform one or more of the functions or operations described herein.

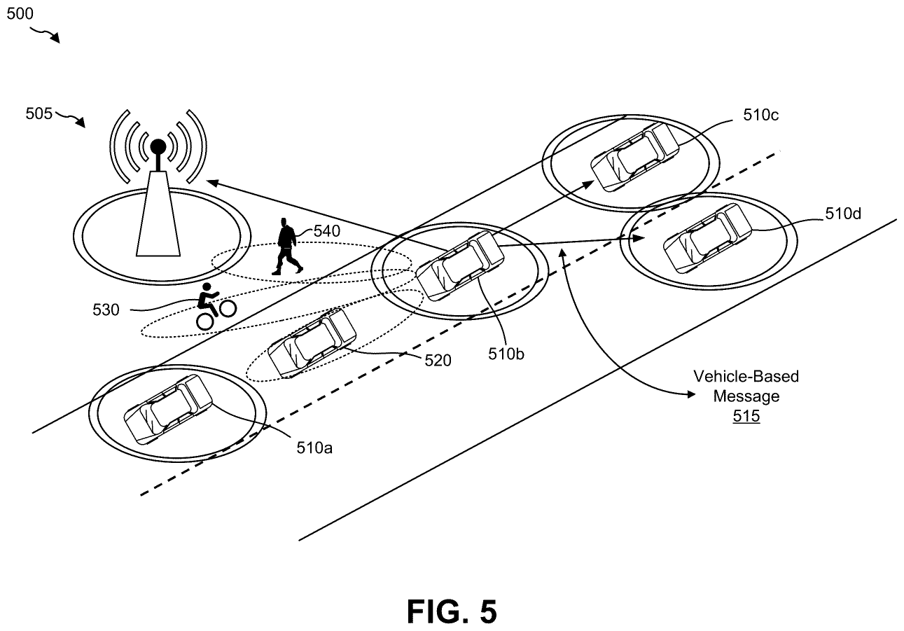

FIG. 5 is a diagram illustrating an example of a system 500 for sensor sharing in wireless communications (e.g., V2X communications). In FIG. 5, the system 500 is shown to include a plurality of equipped (e.g., V2X capable) network devices. The plurality of equipped network devices includes vehicles (e.g., automobiles) 510a, 510b, 510c, 510d, and an RSU 505. Also shown are a plurality of non-equipped network devices, which include a non-equipped vehicle 520, a VRU (e.g., a bicyclist) 530, and a pedestrian 540. The system 500 may include more or less equipped network devices and/or more or less non-equipped network devices, than as shown in FIG. 5. In addition, the system 500 may include more or less different types of equipped network devices (e.g., which may include equipped UEs) and/or more or less different types of non-equipped network devices (e.g., which may include non-equipped UEs) than as shown in FIG. 5. In addition, in one or more examples, the equipped network devices may be equipped with heterogeneous capability, which may include, but is not limited to, C-V2X/DSRC capability, 4G/5G cellular connectivity, GPS capability, camera capability, radar capability, and/or LIDAR capability.

The plurality of equipped network devices may be capable of performing V2X communications. In addition, at least some of the equipped network devices are configured to transmit and receive sensing signals for radar (e.g., RF sensing signals) and/or LIDAR (e.g., optical sensing signals) to detect nearby vehicles and/or objects. Additionally or alternatively, in some cases, at least some of the equipped network devices are configured to detect nearby vehicles and/or objects using one or more cameras (e.g., by processing images captured by the one or more cameras to detect the vehicles/objects). In one or more examples, vehicles 510a, 510b, 510c, 510d and RSU 505 may be configured to transmit and receive sensing signals of some kind (e.g., radar and/or LIDAR sensing signals).

In some examples, some of the equipped network devices may have higher capability sensors (e.g., GPS receivers, cameras, RF antennas, and/or optical lasers and/or optical sensors) than other equipped network devices of the system 500. For example, vehicle 510b may be a luxury vehicle and, as such, have more expensive, higher capability sensors than other vehicles that are economy vehicles. In one illustrative example, vehicle 510b may have one or more higher capability LIDAR sensors (e.g., high capability optical lasers and optical sensors) than the other equipped network devices in the system 500. In one illustrative example, a LIDAR of vehicle 510b may be able to detect a VRU (e.g., cyclist) 530 and/or a pedestrian 540 with a large degree of confidence (e.g., a seventy percent degree of confidence). In another example, vehicle 510b may have higher capability radar (e.g., high capability RF antennas) than the other equipped network devices in the system 500. For instance, the radar of vehicle 510b may be able to detect the VRU (e.g., cyclist) 530 and/or pedestrian 540 with a degree of confidence (e.g., an eight-five percent degree of confidence). In another example, vehicle 510b may have higher capability camera (e.g., with higher resolution capabilities, higher frame rate capabilities, better lens, etc.) than the other equipped network devices in the system 500.

During operation of the system 500, the equipped network devices (e.g., RSU 505 and/or at least one of the vehicles 510a, 510b, 510c, 510d) may transmit and/or receive sensing signals (e.g., RF and/or optical signals) to sense and detect vehicles (e.g., vehicles 510a, 510b, 510c, 510d, and 520) and/or objects (e.g., VRU 530 and pedestrian 540) located within and surrounding the road. The equipped network devices (e.g., RSU 505 and/or at least one of the vehicles 510a, 510b, 510c, 510d) may then use the sensing signals to determine characteristics (e.g., motion, dimensions, type, heading, and speed) of the detected vehicles and/or objects. The equipped network devices (e.g., RSU 505 and/or at least one of the vehicles 510a, 510b, 510c, 510d) may generate at least one vehicle-based message 515 (e.g., a V2X message, such as a Sensor Data Sharing Message (SDSM), a Basic Safety Message (BSM), a Cooperative Awareness Message (CAM), Collective Perception Messages (CPMs), and/or other type of message) including information related to the determined characteristics of the detected vehicles and/or objects.

The vehicle-based message 515 may include information related to the detected vehicle or object (e.g., a position of the vehicle or object, an accuracy of the position, a speed of the vehicle or object, a direction in which the vehicle or object is traveling, and/or other information related to the vehicle or object), traffic conditions (e.g., low speed and/or dense traffic, high speed traffic, information related to an accident, etc.), weather conditions (e.g., rain, snow, etc.), message type (e.g., an emergency message, a non-emergency or “regular” message), etc.), road topology (line-of-sight (LOS) or non-LOS (NLOS), etc.), any combination, thereof, and/or other information. In some examples, the vehicle-based message 515 may also include information regarding the equipped network device's preference to receive vehicle-based messages from other certain equipped network devices. In some cases, the vehicle-based message 515 may include the current capabilities of the equipped network device (e.g., vehicles 510a, 510b, 510c, 510d), such as the equipped network device's sensing capabilities (which can affect the equipped network device's accuracy in sensing vehicles and/or objects), processing capabilities, the equipped network device's thermal status (which can affect the vehicle's ability to process data), and the equipped network device's state of health.

In some aspects, the vehicle-based message 515 may include a dynamic neighbor list (also referred to as a Local Dynamic Map (LDM) or a dynamic surrounding map) for each of the equipped network devices (e.g., vehicles 510a, 510b, 510c, 510d and RSU 505). For example, each dynamic neighbor list can include a listing of all of the vehicles and/or objects that are located within a specific predetermined distance (or radius of distance) away from a corresponding equipped network device. In some cases, each dynamic neighbor list includes a mapping, which may include roads and terrain topology, of all of the vehicles and/or objects that are located within a specific predetermined distance (or radius of distance) away from a corresponding equipped network device.

In some implementations, the vehicle-based message 515 may include a specific use case or safety warning, such as a do-not-pass warning (DNPW) or a forward collision warning (FCW), related to the current conditions of the equipped network device (e.g., vehicles 510a, 510b, 510c, 510d). In some examples, the vehicle-based message 515 may be in the form of a standard Basic Safety Message (BSM), a Cooperative Awareness Message (CAM), a Collective Perception Message (CPM), a Sensor Data Sharing Message (SDSM) (e.g., SAE J3224 SDSM), and/or other format.

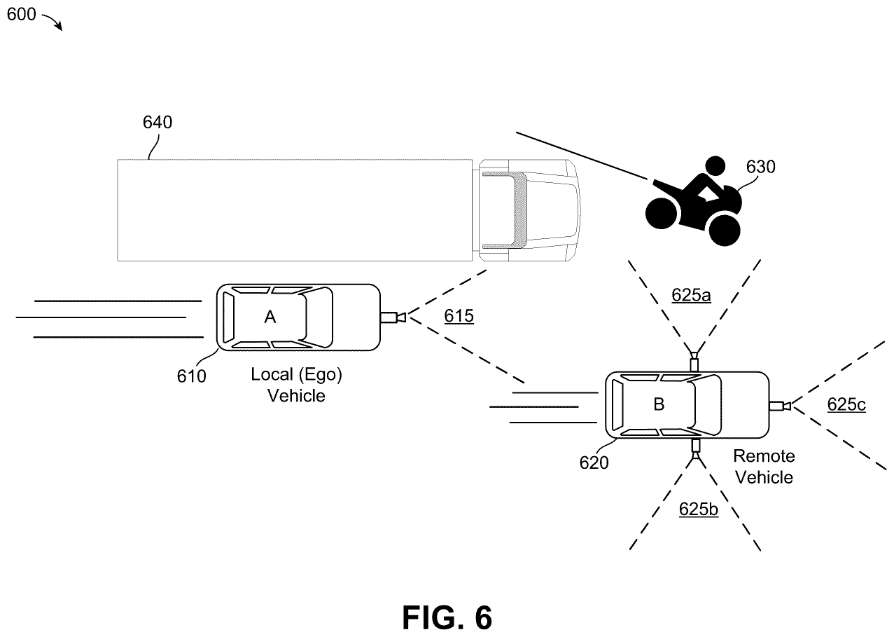

As previously mentioned, a vehicle (e.g., an ego vehicle) may not have an ability to perceive (e.g., via one or more sensors of the ego vehicle) certain regions (e.g., which may include one or more objects) that other nearby vehicles may be able to detect. FIG. 6 shows an example of a vehicle 610 (shown as vehicle A) with a blocked view 615 (e.g., a field of view) of a region including an oncoming object 630 (e.g., a motorcyclist). The vehicle 610 can be referred to as a local vehicle (e.g., an ego vehicle). In FIG. 6, a vehicle 640 (e.g., in the form of a truck) is shown to be blocking the view 615 of the vehicle 610 such that the vehicle 610 cannot detect the oncoming object 630 via one or more sensors of the vehicle 610. In FIG. 6, a vehicle 620 (shown as vehicle B) is shown to have multiple views 625a, 625b, 625c based on multiple sensors of the vehicle 620. The vehicle 620 can be referred to as a remote vehicle. The sensors of the vehicle 620 can include the sensor system(s) 456 of FIG. 4, which can include any combination of cameras, radar sensors, LIDAR sensors, and/or other sensors. The object 630 is shown to be located (and unobstructed) within the view 625a of a sensor of the vehicle 620 and, as such, the vehicle 620 is able to detect the object 630 based on sensor data obtained by the sensor. While the vehicle 620 is able to detect the object 630, the vehicle 610 is unaware of the oncoming object 630 unless the vehicle 620 transfers (e.g., transmits) information associated with the detected object 630 to the vehicle 610.

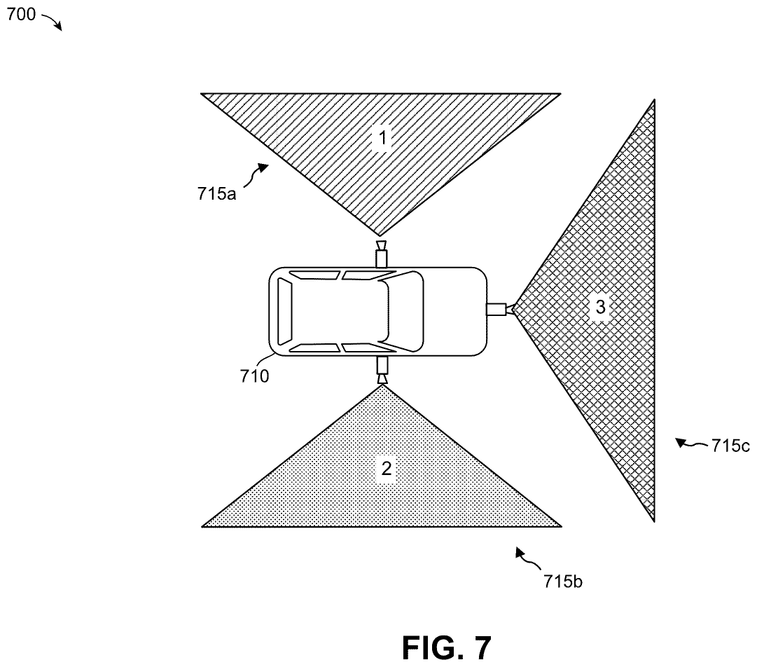

FIG. 7 shows example views of sensors implemented within a vehicle. In particular, FIG. 7 is a diagram illustrating an example 700 of views (e.g., view 1 715a, view 2 715b, and view 3 715c) of sensors associated with a vehicle 710 (e.g., an ego vehicle). In FIG. 7, the vehicle 710 is shown to have a plurality of sensors (e.g., image sensors) mounted on an exterior of the vehicle 710. FIG. 7 shows the views (e.g., view 1 715a, view 2 715b, and view 3 715c) of each of the sensors, respectively.

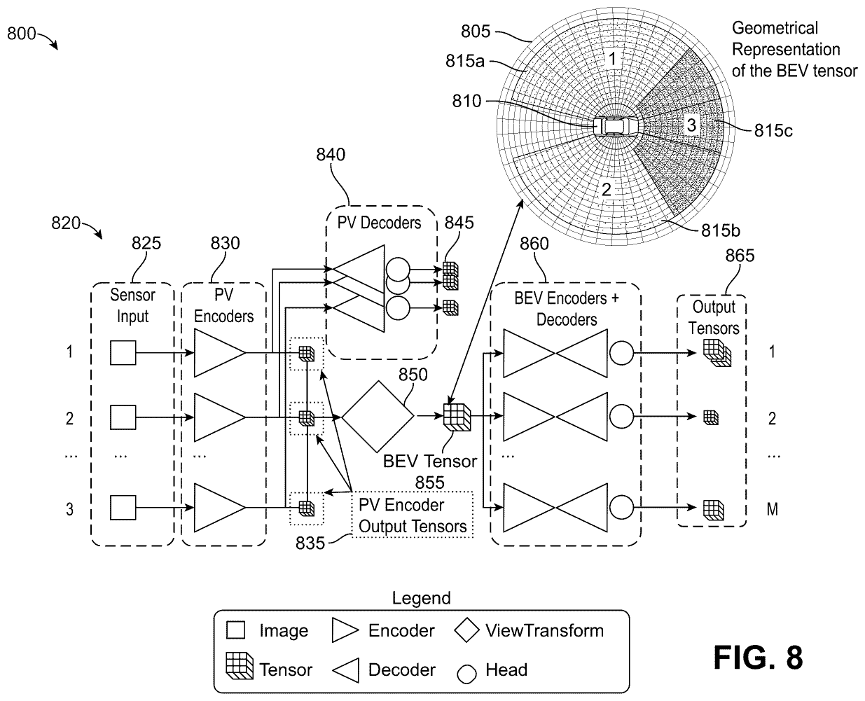

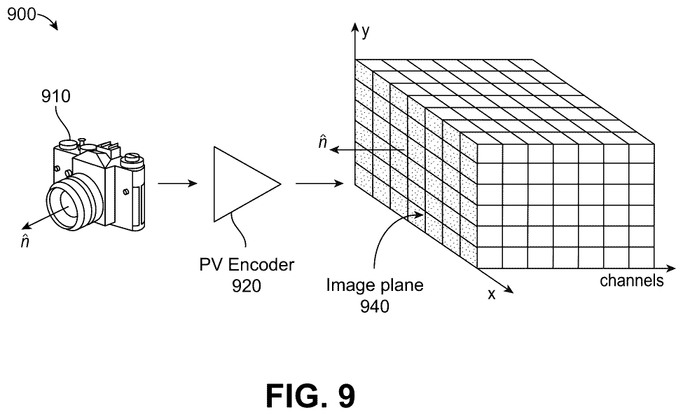

In one or more aspects, low level fusion (LLF) may be utilized for building a real-world model from the perspective of a vehicle, such as an ego vehicle. FIGS. 8 and 9 together show an example of generation of encoder tensors and projection of the encoded tensors onto a top view representation of a vehicle.

FIG. 8 shows an example of LLF, where encoder tensors are projected onto a top view representation of a vehicle. In particular, FIG. 8 is a diagram illustrating an example 800 of a system 820 for obtaining encoder tensors (e.g., perspective view encoder output tensors 835) and projecting the encoder tensors onto a top view representation 805 (e.g., including regions, such as region 1 815a, region 2 815b, and region 3 815c corresponding to views, such as view 1 715a, view 2 715b, and view 3 715c) of a vehicle 810 (e.g., an ego vehicle). In FIG. 8, the top view representation 805 is a bird's eye view (BEV) representation with a grid that represents a model around the vehicle 810, where each cell within the grid contains information about a particular place within a view (e.g., view 1 815a, view 2 815b, or view 3 815c) of the vehicle 810.

In FIG. 8, the system 820 is shown to include multi-sensor LLF perception stacks, which include perspective view (PV) encoders 830, PV decoders 840, and bird's eye view (BEV) encoders and decoders 860. In FIG. 8, the system 820 is shown to include a multi-sensor network output, with M number of network outputs. In the example of FIG. 8, the system 820 includes three (with M equal to three) network outputs. In one or more examples, the system 820 may include more or less network outputs (e.g., two network outputs, four network outputs, or other M number of network outputs) than that shown in FIG. 8. In one or more examples, the system 820 can process sensor data (e.g., image data, radar data, LIDAR data, etc.) using the PV encoders 830 to produce a set of tensors (e.g., PV encoder output tensors 835). Each tensor is a representation (e.g., a compact or abstract representation) of the view (e.g., view 1 715a, view 2 715b, or view 3 715c) of a respective sensor for which each tensor represents.

During operation of the system 820, sensor input 825 (e.g., sensor data, which includes sensor input 1, sensor input 2, and sensor input 3) may be obtained by the vehicle 7810. In one or more examples, the sensor input 1 may be obtained from sensor 1 associated with the vehicle 810, the sensor input 2 may be obtained from sensor 2 associated with the vehicle 810, and the sensor input 3 may be obtained from sensor 3 associated with the vehicle 810. In one or more examples, the sensors (e.g., sensor 1, sensor 2, and sensor 3) may be in the form of image sensors, radar sensors, and/or Lidar sensors. In the example shown in FIG. 8, the sensors are in the form of image sensors. In one or more examples, the sensor input 1 can include information (e.g., image data) associated with the view 1 815a of the vehicle 810, the sensor input 2 can include information (e.g., image data) associated with the view 2 815b of the vehicle 810, and the sensor input 3 can include information (e.g., image data) associated with the view 3 815c of the vehicle 810.

The sensor input 825 (e.g., including sensor input 1, sensor input 2, and sensor input 3) may be inputted (e.g., fed) into the PV encoders 830 (e.g., which may include neural networking layers, such as a convolutional neural network (CNN)). The PV encoders 830 can, based on the sensor input 825, produce the PV encoder output tensors 835. The PV encoder output tensors 835 may be reduced in dimensionality (as compared to the sensor input) and encoded to meet certain criteria (e.g., to allow for an efficient projection into an environment model, such as the top view representation 805). Each of the PV encoder output tensors 835 can represent features covered within its corresponding view (e.g., view 1 715a, view 2 715b, or view 3 715c).

The PV encoder output tensors 835 can then be sent to a view transform 850. The view transform 850 can project the PV encoder output tensors 835 onto the top view representation 805 to produce a BEV tensor 855. The BEV tensor 855 can include an aggregated abstraction of the sensor data from the vehicle 810 (e.g., representing what the vehicle 810 has perceived about the world via its sensors, such as sensor 1, sensor 2, and sensor 3). The top view representation 805 includes regions (e.g., region 1 815a, region 2 815b, and region 3 815c) that correspond to the views (e.g., view 1 715a, view 2 715b, and view 3 715c) of the vehicle 810. The view transform 850 can be implemented in many different ways. In some aspects, a virtual point cloud can be created for each camera by estimating a discrete depth distribution for each pixel in the PV feature map of the PV encoder output tensors 835, by which the features are weighted before projection and aggregation into a top-view grid of the BEV tensor 855. In some aspects, a transformer-based approach can be used (e.g., using a transformer neural network model) in which each top-view grid cell of the BEV tensor 855 is populated by feeding a grid cell query into a spatial cross-attention module where keys and values are generated by the PV encoders 830. Other techniques can also be used to implement the view transform 850.

The BEV tensor 855 can then be inputted (e.g., fed) into the BEV encoders and decoders 860. The BEV encoders and decoders 860, based on the BEV tensor 855, can produce output tensors 865. The output tensors 865 can represent different objects of interest detected in the real world. For example, an output tensor 865 may be a representation of the probability of a vehicle or a pedestrian being located at a particular place within one of the region (e.g., (e.g., region 1 815a, region 2 815b, or region 3 815c) corresponding to the views (e.g., view 1 715a, view 2 715b, or view 3 715c). In some examples, an output tensor 865 may be a representation of a model of a road (e.g., a polynomial describing the road) ahead that the vehicle 810 is traveling on. In one or more examples, an output tensor 865 may be a representation of the probability and type of different traffic signs. In some examples, an output tensor 865 may include a listing of remote vehicles that are surrounding the vehicle 810.

The PV encoder output tensors 835 can also be inputted (e.g., fed) into the PV decoders 840. The PV decoders 840, based on the PV encoder output tensors 835, can be used to produce PV decoder output tensors 845. The PV decoder output tensors 845 can be used for various different purposes, such as detecting whether a particular sensor has been blocked due to a blockage or an over illumination (e.g., a dazzling) by bright lights.

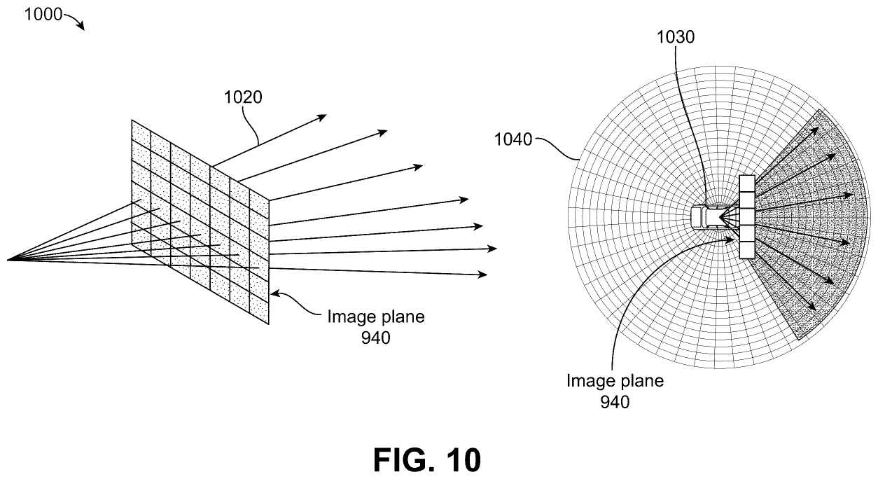

FIGS. 9 and 10 together illustrate the generation and projection of a 3D tensor representation 930 (e.g., including a PV encoder output tensor) onto a top view representation 1040 of a vehicle 1030. FIG. 9 shows an example of generation of a raw PV encoder output tensor (e.g., a PV encoder output tensor 835 of FIG. 8). In particular, FIG. 9 is a diagram illustrating an example 900 of generating a 3D tensor representation of sensor data, which may be in the form of an image. In FIG. 9, a sensor (e.g., in the form of a camera 910) may obtain sensor data (e.g., in the form of an image) of an environment of a vehicle 1030 of FIG. 10. In one or more examples, a sensor (e.g., a radar sensor or Lidar sensor) other than a camera (e.g., image sensor) as shown in FIG. 9 may be employed to obtain the sensor data (e.g., radar data or Lidar data).

The sensor data (e.g., an image) may then be inputted into a PV encoder 920 (e.g., a PV encoder 830 of FIG. 8). The PV encoder 920, based on the image, can then produce a 3D tensor representation 930 (e.g., including a PV encoder output tensor) of the original image. The 3D tensor representation 930 is shown to include an image plane 940. The image plane 940 is shown to be perpendicular to the normal vector (n) of the camera 910. Two of the dimensions (e.g., the image plane 940) of the 3D tensor representation 930 lie parallel to the image coordinates, which are typically scaled down by a same radix-2 factor (e.g., 1920×960 is scaled down to 60×30). The third dimension of the 3D tensor representation 930 can include abstract feature encodings, which may be chosen by the training of the network (e.g., of the PV encoder 920). This third dimension can, typically, include a few tens to hundreds of channels (e.g., where each can be represented by a cell within the 3D tensor representation 930).

FIG. 10 is a diagram 1000 illustrating an example of projecting an image plane 940 of the 3D tensor representation 930 onto a top view representation 1040 (e.g., a BEV representation) of a view of a vehicle 1030. In some aspects, the projection can be performed by the view transform 850 of FIG. 8. In FIG. 10, the image plane 940 remains perpendicular to the normal vector (n) of the camera 910. Each channel row at (x, y) of the 3D tensor representation 930 is projected (e.g., projections 1020) onto the top view representation 1040 (e.g., a BEV space) for the vehicle 1030. The image plane projection in the view transform can cover the entire sensor (e.g., camera 910) field of view. As such, the PV encoder output tensor is an abstract representation of what a sensor detects in a particular direction, for a particular point in time, efficiently encoded and with a clear relation to the geometry of the problem. Therefore, since the PV encoder output tensor is efficient and with geometric properties that transform well between vehicles, the PV encoder output tensor is well suited for transfer between vehicles.

In one or more aspects, the PV encoder output tensor may be optimized. In one or more examples, the PV encoder output tensor may be optimized by using a neural architecture search. By subjecting the LLF network (e.g., PV encoder) to a neural architecture search (NAS), certain structural parameters of the network can be optimized. In particular, it is desirable to have the most compact representation possible of transferred items and, in particularly, the PV encoder output tensor. As such, the size (e.g., width, height, and number of channels) of the PV encoder output tensor may be added to the NAS search parameters, and the tensor size cost term can be added to the loss function of the NAS training by:

$${l}_{s i z e} = c {W}_{i} {H}_{i} {N}_{i} ,$$

or more generally, by:

$${l}_{s i z e} = f ( {W}_{i} , {H}_{i} , {N}_{i} ) ,$$

where Wᵢ is equal to a tensor width, Hᵢ is equal to a tensor height, Nᵢ is equal to a a number of channels of the tensor, and c is equal to a proportionality constant. This formulation will reward small tensor sizes.

In some examples, the PV encoder output tensor may be optimized by using sparsity and pruning. An alternative to NAS for optimizing the PV encoder output tensor may be to train a model with an initially over-dimensioned PV encoder output tensor with a regularizing loss term (e.g., l₁-regularization) that encourages structural sparsity, and thereby enables removal of feature channels as a post-processing step.

In one or more aspects, LLF involves the view transform (e.g., view transform 850 of FIG. 8) combining (e.g., adding) input from different sensors (e.g., images sensors) into the regions covered by views of different sensors. From the regions where the views of the sensors overlap geometrically, information can be obtained from multiple sensors, which can greatly enhance the world model accuracy and detection performance.

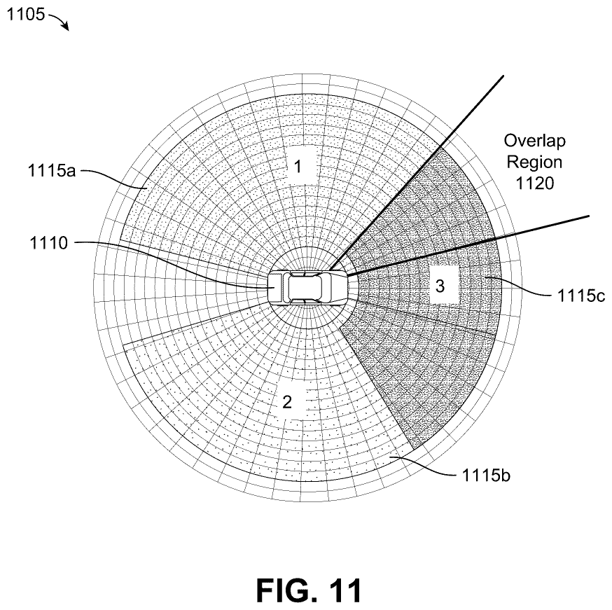

FIG. 11 shows an example of overlapping regions (e.g., forming an overlap area 1120), where views of sensors of a vehicle 1110 overlap geometrically. In particular, FIG. 11 illustrates a top view representation 1105 of the vehicle 1110 with an overlap region 1120. In FIG. 11, the top view representation 1105 is shown to include regions (e.g., region 1 1115a, region 2 1115b, and region 3 1115c) that correspond to the views of the sensors on the vehicle 1110. In FIG. 11, region 1 1115a and region 3 1115c are shown to overlap to form the overlap region 1120.

In one or more examples, the combination of the regions (e.g., region 1 1115a, region 2 1115b, and region 3 1115c) is “additive” in nature, which makes it possible to combine multiple sensor inputs with an increase in performance with each added sensor input. However, the combination of the regions can also work in reverse, where the loss of a sensor input can degrade the performance in the direction of that sensor in proportion to its contribution to the total sensor information in that direction. As such, this “additive” characteristic makes it possible to dynamically add or remove sensor inputs, while still maintaining service, which will be gracefully degraded or enhanced.

In one or more examples, the sensors may have sensor types that can include cameras (e.g., image sensors), radar sensors, and/or Lidar sensors. The geometric shape of a region (e.g., region of interest) may be rectangular, circular, a sector, or any other geometric shape. The shape may or may not be distorted. The sensors may be linearly spaced or non-linearly spaced.

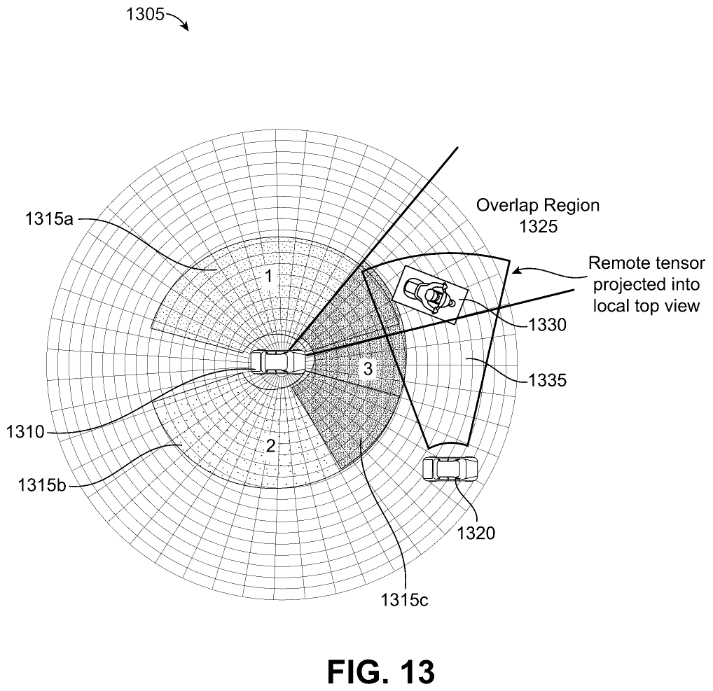

As previously mentioned, in one or more aspects, the systems and techniques provide solutions for inter-vehicle LLF tensor transfer. In one or more examples, “encoder tensors” (e.g., PV encoder output tensors 1246) may be transferred between vehicles (e.g., between a remote vehicle 1220 and a local vehicle 1210), such that a local view transform (e.g., view transform 1260) can insert the encoder tensors into a local top review representation (e.g., top view representation 1305 of FIG. 13) alongside with local encoder tensors (e.g., PV encoder output tensors 1245) to improve the detection range, accuracy, and/or to obtain coverage for obscured parts of a view of a local vehicle (e.g., the local vehicle 1210, which may be in the form of an ego vehicle). In one or more examples, this tensor transfer can be performed by extracting an encoder tensor (e.g., PV encoder output tensor 1246) generated at a remote vehicle (e.g., remote vehicle 1220), transmitting (e.g., transferring) the extracted encoder tensor (e.g., PV encoder output tensor 1246) to a local vehicle (e.g., local vehicle 1210, such as an ego vehicle), and providing the extracted encoder tensor (e.g., PV encoder output tensor 1246) to a local view transform (e.g., view transform 1260). The transmitted encoder tensor (e.g., PV encoder output tensor 1246) may be run through a local re-coder (e.g., re-coder 1285), before entering into the local view transform (e.g., view transform 1260), to make adaptations to the encoder tensor (e.g., PV encoder output tensor 1246) needed for the local vehicle system.

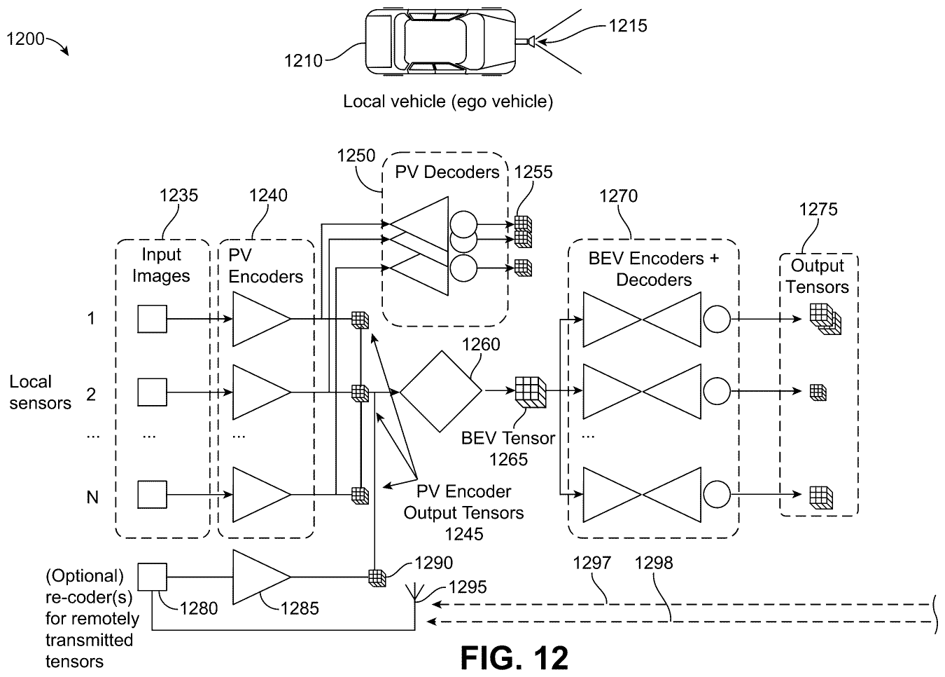

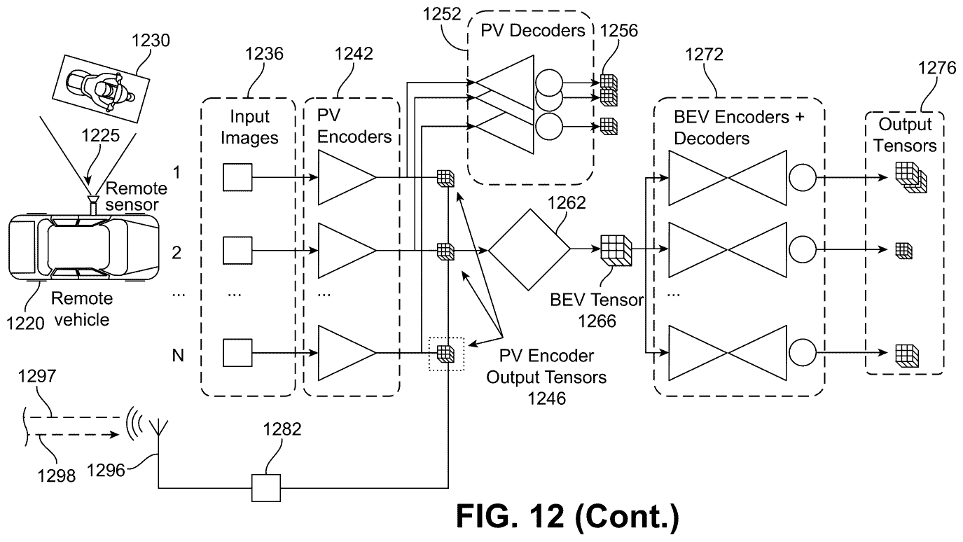

FIG. 12 shows an example of inter-vehicle LLF tensor transfer. In particular, FIG. 12 is a diagram illustrating an example of a system 1200 for inter-vehicle low-level fusion tensor transfer. In FIG. 12, a remote vehicle 1220 has a sensor (e.g., a remote sensor, such as an image sensor) with a view 1225. Within the view 1225, an object 1230 (e.g., a motorcyclist) is shown. In FIG. 12, a system of the remote vehicle 1220 is shown to include multi-sensor network outputs, which include PV encoders 1242, PV decoders 1252, and BEV encoders and decoders 1272. In FIG. 12, the system of the remote vehicle 1220 is shown to include M number of network outputs, where M is equal to three (3). The system of the remote vehicle 1220 may include more or less multi-sensor network outputs (e.g., two network outputs, four network outputs, etc.) than as shown in FIG. 12.

During operation of the system of the remote vehicle 1220, sensor input 1236 (e.g., sensor data, which includes sensor input 1, sensor input 2, and sensor input 3) may be obtained by sensors (e.g., remote sensors) of the remote vehicle 1220. The sensor input 1 may be obtained from sensor 1 associated with the remote vehicle 1220, the sensor input 2 may be obtained from sensor 2 associated with the remote vehicle 1220, and the sensor input 3 may be obtained from sensor 3 associated with the remote vehicle 1220. The sensors (e.g., sensor 1, sensor 2, and sensor 3) may be in the form of image sensors, radar sensors, and/or Lidar sensors. In the example shown in FIG. 12, the sensors are in the form of image sensors. In one or more examples, the sensor input 3 can include information (e.g., image data) associated with the view 1225 of the remote vehicle 1220.

The sensor input 1236 (e.g., including sensor input 1, sensor input 2, and sensor input 3) may be inputted (e.g., fed) into the PV encoders 1242 (e.g., including neural networking layers, such as a CNN). The PV encoders 1242 can, based on the sensor input 1236, produce the PV encoder output tensors 1246. The PV encoder output tensors 1246 may be reduced in dimensionality (as compared to the sensor input) and encoded to meet certain criteria (e.g., to allow for an efficient projection into an environment model, such as the top view representation 1305 of FIG. 13). Each of the PV encoder output tensors 1246 may represent features covered within its corresponding view (e.g., view 1225).

The PV encoder output tensors 1246 may be sent to a view transform 1262. The view transform 1262 may project the PV encoder output tensors 1246 onto a top view representation (e.g., top view representation 1305 of FIG. 13) to produce a BEV tensor 1266. The BEV tensor 1266 can include an aggregated abstraction of the sensor data from the remote vehicle 1220 (e.g., representing what the remote vehicle 1220 perceives about the world via its sensors). The BEV tensor 1266 can then be inputted (e.g., fed) into the BEV encoders and decoders 1272. The BEV encoders and decoders 1272, based on the BEV tensor 1266, can produce output tensors 1276. The output tensors 1276 can represent different objects of interest detected in the real world. For example, an output tensor 1276 may be a representation of the probability of the object 1230 being located at a particular place within a region corresponding to the view 1225.

The PV encoder output tensors 1246 can also be inputted (e.g., fed) into the PV decoders 1252. The PV decoders 1252, based on the PV encoder output tensors 1246, can be used to produce PV decoder output tensors 1256. The PV decoder output tensors 1256 can be used for various different purposes, for example for detecting whether a particular sensor has been blocked due to a blockage or an over illumination (e.g., a dazzling) by bright lights.

In FIG. 12, the local vehicle 1210 (e.g., an ego vehicle) has a sensor (e.g., a local sensor, such as an image sensor) with a view 1215. Within the view 1215, a region including the object 1230 may be obscured in sensor data from the sensor due to one or more factors. For example, the region may be obscured in the sensor data based on a view of the sensor being obstructed or blocked, the sensor being broken, the sensor being dirty, the sensor being blinded by low sun or oncoming headlights, the first sensor (e.g., a radar or LIDAR sensor) experiencing interference from other active sensors from other vehicles or road-side installations (e.g., roadside units (RSUs)), any combination thereof, and/or other factor(s) affecting the view of the sensor. In FIG. 12, a system of the local vehicle 1210 is shown to include multi-sensor network outputs, which include PV encoders 1240, PV decoders 1250, and BEV encoders and decoders 1270. In FIG. 12, the system of the local vehicle 1210 is shown to include M number of multi-sensor network outputs, where M is equal to three (3). The system of the local vehicle 1210 may include more or less multi-sensor network outputs than as shown in FIG. 12.

During operation of the system of the local vehicle 1210, sensor input 1235 (e.g., sensor data, which includes sensor input 1, sensor input 2, and sensor input 3) may be obtained by sensors (e.g., local sensors) of the local vehicle 1210. The sensor input 1 may be obtained from sensor 1 associated with the local vehicle 1210, the sensor input 2 may be obtained from sensor 2 associated with the local vehicle 1210, and the sensor input 3 may be obtained from sensor 3 associated with the local vehicle 1210. The sensors (e.g., sensor 1, sensor 2, and sensor 3) may be in the form of image sensors, radar sensors, and/or Lidar sensors. In the example shown in FIG. 12, the sensors are in the form of image sensors. In some examples, the sensor input 3 may include information (e.g., image data) associated with the view 1215 of the local vehicle 1210.

The sensor input 1235 (e.g., including sensor input 1, sensor input 2, and sensor input 3) may be inputted (e.g., fed) into the PV encoders 1240 (e.g., including neural networking layers, such as a CNN). The PV encoders 1240 can, based on the sensor input 1235, produce PV encoder output tensors 1245. The PV encoder output tensors 1245 may be reduced in dimensionality (as compared to the sensor input) and encoded to meet certain criteria (e.g., to allow for an efficient projection into an environment model, such as the top view representation 1305 of FIG. 13). Each of the PV encoder output tensors 1245 can represent features covered within its corresponding view (e.g., view 1215).

In one or more examples, the local vehicle 1210 (e.g., an ego vehicle) may have an obstruction (or at least a partial obstruction) in one or more of the views (e.g., view 1215) of the local vehicle 1210 such that a region including the object 1230 is obstructed (or at least partially obstructed) within one or more views (e.g., view 1215) of the local vehicle 1210. The PV encoder output tensor 1246, associated with the view 1225 that includes the object 1230, may be sent from the remote vehicle 1220 to the local vehicle 1210 for the local vehicle 1210 to be able to detect the object 1230.

In one or more examples, the PV encoder output tensor 1246 (e.g., associated with the view 1225 that includes the object 1230) may be sent to a transmitter 1282 or transmitter/receiver (e.g., associated with the remote vehicle 1220) for transmission by an antenna 1296 (e.g., a transmit or transmit/receive antenna associated with the remote vehicle 1220). In some cases, the remote vehicle can transmit the BEV tensor 1266 or a portion thereof via the transmitter 1282/antenna 1296 for use by the local vehicle 1210. Providing the BEV tensor 1266 has an advantage of simpler processing by the local vehicle 1210 (e.g., an affine transform of the remote BEV tensor 1266 by the local vehicle 1210 based on the relative position and orientation of the remote and local vehicles and addition to the local BEV tensor 1265.

The antenna 1296 can wirelessly transmit (e.g., via signal 1297) the PV encoder output tensor 1246 (e.g., associated with the view 1225 that includes the object 1230), or in some cases the BEV tensor 1266, to an antenna 1295 (e.g., a receive antenna or a transmit/receive antenna) associated with a local vehicle 1210 (e.g., an ego vehicle). In one or more examples, the signal 1297 may be wirelessly transmitted through wireless means including, but not limited to, 3G, 4G, 5G, 6G, Wi-Fi, etc. After the antenna 1295 receives the PV encoder output tensor 1246 (e.g., associated with the view 1225 that includes the object 1230), a receiver 1280 or transmitter/receiver can receive the PV encoder output tensor 1246 (e.g., associated with the view 1225 that includes the object 1230).

In some examples, the received PV encoder output tensor 1246 (e.g., associated with the view 1225 that includes the object 1230) can then be inputted (e.g., fed) into a re-coder 1285. The re-coder 1285, based on the received PV encoder output tensor 1246, can adapt the received PV encoder output tensor 1246 to produce a PV encoder output tensor 1290 that is compatible with the system associated with the local vehicle 1210 (e.g., such that the produced PV encoder output tensor 1290 is in a format used by the system associated with the local vehicle 1210). The PV encoder output tensor 1290 (along with the PV encoder output tensors 1245) can then be inputted into a view transform 1260. The view transform 1260 may project the PV encoder output tensors 1290, 1245 onto a top view representation (e.g., top view representation 1305 of FIG. 13) to produce a BEV tensor 1265. The BEV tensor 1265 can include an aggregated abstraction of the sensor data from the local vehicle 1210 and the remote vehicle 1220 (e.g., representing what the local vehicle 1210 perceives about the world via its sensors what the remote vehicle 1220 perceived within view 1225). The BEV tensor 1265 can then be inputted (e.g., fed) into the BEV encoders and decoders 1270. The BEV encoders and decoders 1270, based on the BEV tensor 1265, can produce output tensors 1275. The output tensors 1275 can represent different objects of interest (e.g., including object 1230) detected in the real world.

In some aspects, the PV encoder output tensors 1245 and the PV encoder output tensor 1290 can also be inputted (e.g., fed) into the PV decoders 1250. The PV decoders 1250, based on the PV encoder output tensors 1245 and the PV encoder output tensor 1290, can be used to produce PV decoder output tensors 1255. The PV decoder output tensors 1255 can be used for various different purposes, for example for detecting whether a particular sensor has been blocked due to a blockage or an over illumination (e.g., a dazzling) by bright lights.

In one or more examples, the term “encoder tensors” (e.g., PV encoder output tensors) can be interpreted broadly, such that “encoder tensors” may contain all the information (e.g., the sensor data itself along with “meta information” such as the type of the sensor, a time stamp for when the sensor data was obtained, a field of view of the sensor, a mounting position of the sensor, an angle of the vehicle associated with the sensor, a position of the vehicle associated with the sensor, etc.) necessary for the projection of the encoder tensor onto a top view representation. The view transform can utilize this information when the view transform calculates the exact projection coordinates for the top view representation. In some examples, the system of a local vehicle may reject a PV encoder output tensor from a remote vehicle if the locally perceived position of the remote vehicle differs too much (e.g., is greater than a threshold amount) from the position provided by the PV encoder output tensor from the remote vehicle.

In one or more examples, the local vehicle 1210 may determine that a region of interest (ROI) within a view 1215 of the local vehicle 1210 is obstructed. The local vehicle 1210 may transmit a request (e.g., a query) wirelessly (e.g., via signal 1298) to one or more remote vehicles (e.g., which may include remote vehicle 1220) requesting encoder tensors (e.g., PV encoder output tensor 1246) associated with the region of interest. In one or more examples, the query/exchange protocol may be bidirectional (e.g., via signal 1298). By making the query/exchange protocol may be bidirectional, the local vehicle 1210 may send queries to one or more remote vehicles (e.g., which may include the remote vehicle 1220) as to which sensor the local vehicle has that is obstructed, and may subsequently subscribe to a specified set of remote vehicles that have views of the region of interest.

In one or more aspects, a remote vehicle can “insert” information into a local top view representation to enable (e.g., for the local vehicle) the detection of objects and features located outside the range of local sensors of the local vehicle, and detection of objects that may be obscured within views of the local sensors of the local vehicle (e.g., based on a view of the local sensors being obstructed or blocked, the local sensors being broken, the local sensors being dirty, the local sensors being blinded by low sun or oncoming headlights, the local sensors (e.g., a radar or LIDAR sensor) experiencing interference from other active sensors from other vehicles or road-side devise or systems (e.g., RSUs), any combination thereof, and/or other factor(s) affecting the view of the local sensors). In one or more examples, the remote vehicle can provide to the local vehicle a second viewpoint of an object that is not dazzled (e.g., over illuminated) in the view of the remote vehicle by oncoming headlights or confusing radar signal echoes. The second viewpoint can enhance the confidence of detection of objects or features, position, velocity, or other meta data associated with the object or feature.

FIG. 13 shows a region (e.g., produced from a remote encoder tensor) including an out-of-range object (e.g., a motorcyclist) projected onto a local top view representation of a local vehicle. In particular, FIG. 13 is a diagram illustrating an example of a top view representation 1305 of a vehicle 1310 (e.g., a local vehicle, such as an ego vehicle) with an object 1330 (e.g., a motorcyclist) located out of range of the view. The top view representation 1305 (e.g., local top view representation) includes regions (e.g., region 1 1315a, region 2 1315b, and region 3 1315c) that correspond to the views of sensors of the vehicle 1310 (e.g., a local vehicle). The regions 1315a, 1315b overlap to form overlap region 1325.

The top view representation 1305 is shown to also include a vehicle 1320 (e.g., a remote vehicle) located out of range of view (e.g., not located within the regions). The top view representation 1305 also shows a region 1335, corresponding to a view of the vehicle 1320 (e.g., remote vehicle), that includes the object 1330. The region 1335 is produced by a remote encoder tensor being projected onto the top view representation 1305 (e.g., local top view representation).

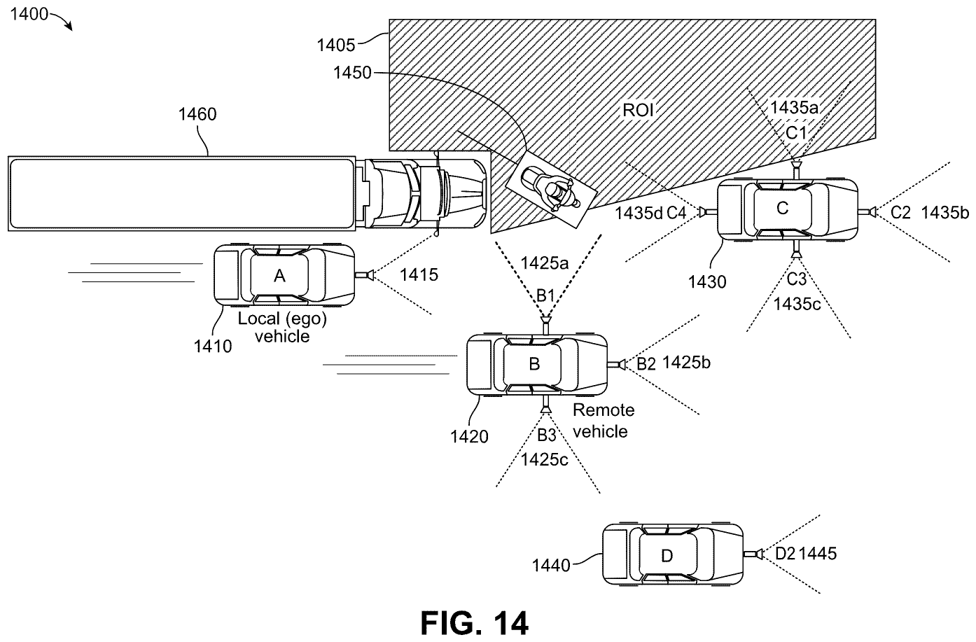

In one or more examples, a vehicle (e.g., a local vehicle) may send requests (e.g., queries) to one or more vehicles (e.g., one or more remote vehicles) for information associated with a region of interest. FIG. 14 shows an example of a local vehicle sending requests for information about a region of interest. In particular, FIG. 14 is a diagram illustrating an example 1400 showing a vehicle 1410 (e.g., vehicle A, a local vehicle) with a blocked view 1415 of a region of interest 1405, sending requests to other nearby vehicles 1420, 1430 (e.g., vehicles B and C) for information associated with the region of interest 1405.

In FIG. 14, the vehicle 1410 (e.g., vehicle A, a local vehicle) is shown to have a view 1415. An occluded region (e.g., the region of interest 1405), including an object 1450 (e.g., a motorcyclist), is shown to be blocked (e.g., occluded) within the view 1415 by a vehicle 1460 (e.g., in the form of a truck). Since the occluded region (e.g., region of interest 1405) is blocked in the view 1415, the vehicle 1410 may identify the occluded region as a region of interest 1405. The vehicle 1410 can send out requests (e.g., queries) to nearby vehicles 1420, 1430, 1440 located in the vicinity for sensors with views covering the region of interest 1405. After receiving the requests, the vehicles 1420, 1430, 1440 can send responses (e.g., replies) to the vehicle 1410 regarding which sensors they have that have views covering the region of interest 1405.

In FIG. 14, the vehicle 1420 (e.g., vehicle B, a remote vehicle) is shown to include views 1425a, 1425b, 1425c obtained by sensors B1, B2, and B3, respectively. The vehicle 1430 (e.g., vehicle C, a remote vehicle) is shown to include views 1435a, 1435b, 1435c obtained by sensors C1, C2, C3, C4, respectively. The vehicle 1440 (e.g., vehicle D, a remote vehicle) is shown to include view 1445 obtained by sensor D2. The view 1425a of the vehicle 1420 and the views 1435a, 1435d of the vehicle 1430 are shown to have unobstructed views of the region of interest 1405. The view 1425a of the vehicle 1420 and the view 1435d of the vehicle 1430 are shown to have unobstructed views of the object 1450 within the region of interest 1405. As such, vehicles 1420, 1430 would send responses indicating that sensors B1, C1, and C4 have views that cover the region of interest 1405. Vehicle 1440 would send an empty response, which would indicate that vehicle 1440 does not have any sensors that cover the region of interest 1405.

After receiving the responses from the vehicles 1420, 1430, 1440, the vehicle 1410 can subscribe to the sensors (e.g., sensors B1, C1, and C4) of the vehicles (e.g., vehicles 1420, 1430) that have views (e.g., views 1425a, 1435a, 1435d) of the region of interest 1405. After subscribing to the sensors, vehicles 1420, 1430 can send (e.g., transmit), to the vehicle 1410, encoder tensors associated with the views 1425a, 1435a, 1435d associated with the sensors B1, C1, and C4.

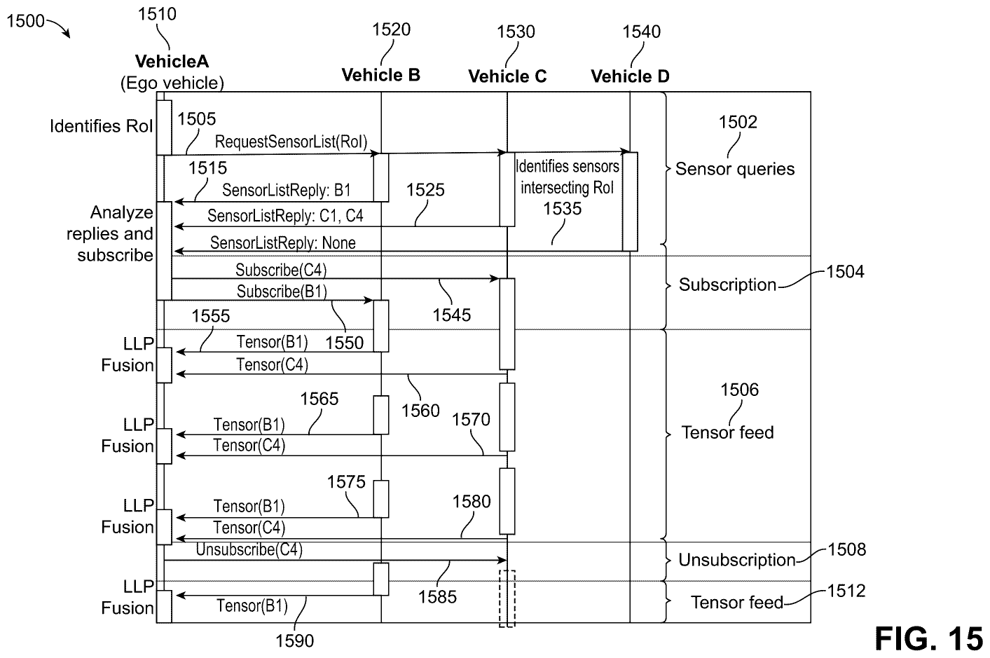

FIG. 15 shows an example of an interaction for the processes of sensor queries 1502, sensor subscription 1504, sensor unsubscription 1508, and tensor feed 1506, 1512. The processes of sensor subscription 1504 and sensor unsubscription 1508 may be triggered by the appearance or disappearance of regions of interest (e.g., which may occur due to a vehicle moving in or out of range, changes in the sensors' capability to detect the regions of interest due to, for example, blockage, occlusion etc. The sensor subscription 1504 and sensor unsubscription 1508 processes may occur in parallel with the tensor feed 1506, 1512 process and the sensor queries 1502 process.

In particular, FIG. 15 is a signaling diagram illustrating an example of communications 1500 for a vehicle 1510 (e.g., vehicle A, a local vehicle, which may be in the form of an ego vehicle) requesting nearby vehicles 1520, 1530, 1540 (e.g., vehicles B, C, D, respectively, for example remote vehicles) for information associated with a region of interest.

During operation of the communications 1500, the vehicle 1510 may identify a region of interest. The vehicle 1510 may then send a signal 1505, to the vehicles 1520, 1530, 1540, requesting a sensor listing for the region of interest (e.g., RequestSensorList(RoI)). In one or more examples, the RequestSensorListRoI can be sent to vehicle located in the vicinity of vehicle 1510. The region of interest may be specified as a geometric shape, such as a circle, rectangle, generic polygon, or a similar shape in world coordinates.

In one or more examples, a vehicle (e.g., vehicle 1510) may identify a region of interest based on a region being occluded by moving or stationary objects, a region being located beyond the detection range or view of the vehicle's 1510 (e.g., ego vehicle) sensors, one or more sensors of the vehicle 1510 ceasing to operate properly thereby leaving blind spots, weather conditions that reduce the confidence of detections in some region, the need to characterize only partially visible structures (e.g., the length of a truck) only seen from behind (e.g., when a take-over maneuver is planned).

In response, the vehicles 1520, 1530, 1504 may identify their sensors that have views intersecting the region of interest. The vehicles 1520, 1530, 1504 may send then signals 1515, 1525, 1535 with sensor lists (e.g., SensorListReply) indicating their sensors that have views covering the region of interest. For example, vehicle 1520 can indicate in signal 1515 that sensor B1 covers the region of interest, vehicle 1530 can indicate in signal 1525 that sensors C1 and C4 cover the region of interest, and vehicle 1530 can indicate in signal 1525 (e.g., which is empty) that no sensors cover the region of interest.

In one or more examples, the SensorListReply can provide a list of sensors, which have views that overlap the specified region of interest. Each sensor entry can provide information about its vehicle-unique identity, position, orientation, and covered region (e.g., in world coordinates). Optionally, each sensor entry can also provide the sensor type (e.g., of camera, radar sensor, Lidar sensor, etc.), frame rate, resolution, etc. The sensor list may be empty if no matching sensors were found.

In response to receiving the signals 1515, 1525, 1535, the vehicle 1510 can analyze the replies in the signals 1515, 1525, 1535 to determine which sensors to subscribe to. After analyzing the replies, the vehicle 1510 can send signals 1545, 1550 to vehicles 1520, 1530 requesting to subscribe (e.g., subscriptions) to sensors C4 and B1, respectively. In one or more examples, the subscriptions can contain the identity of the requested sensor, along with optional qualifiers for the delivery (e.g., the sending rate, quality, compression, etc.).

In response to receiving the signals 1545, 1550, the vehicles 1520, 1530 can send signals 1550, 1560 including tensors for sensors B1 and C4, respectively. In one or more examples, the tensors can include the raw encoder tensor information, along with a timestamp of when the sensor obtained sensor data associated with the tensor information, a mounting position of the sensor at the time of obtaining the sensor data, and an orientation of the sensor at the time of obtaining the sensor data. In some examples, the tensors can include sensor diagnostics regarding blockage or a degraded operation.

After receiving the tensors, the vehicle 1510 can perform LLF utilizing the tensors. After some time has passed, the vehicles 1520, 1530 may then send signals 1565, 1570 including tensors for sensors B1 and C4, respectively. After receiving the tensors, the vehicle 1510 can again perform LLF utilizing the newly received tensors. After more time has passed, the vehicles 1520, 1530 may then send signals 1575, 1580 including tensors for sensors B1 and C4, respectively. After receiving the tensors, the vehicle 1510 can again perform LLF utilizing the newly received tensors. The vehicle 1510 may then send a signal 1585 to vehicle 1530 requesting to unsubscribe (e.g., unsubscription) to sensor C4. The vehicles 1520 may then send a signals 1590 including an tensor for sensor B1. In one or more examples, the unsubscription can contain the identity of the unsubscribed sensor. After receiving the tensor, the vehicle 1510 can again perform LLF utilizing the newly received tensor. The vehicle 1520 will continue to send signals including an tensor for sensor B1, until the vehicle 1520 receives a signal from vehicle 1510 requesting to unsubscribe to sensor B1.

In one or more aspects, to establish (e.g., by a local vehicle) a direct connection to a remote vehicle, the remote vehicles's GNSS position may be established by local measurements. Additional identity information may potentially collected, such as the license plate number or some physical properties (e.g., color or type of vehicle). Using this information, the electronic identity of the remote vehicle can be established through a remote V2V service, and a contact can be initiated with the remote vehicle. This connection may be indirect, via the service, or direct to the remote vehicle. A direct connection may be desired if possible, due to latency restrictions.

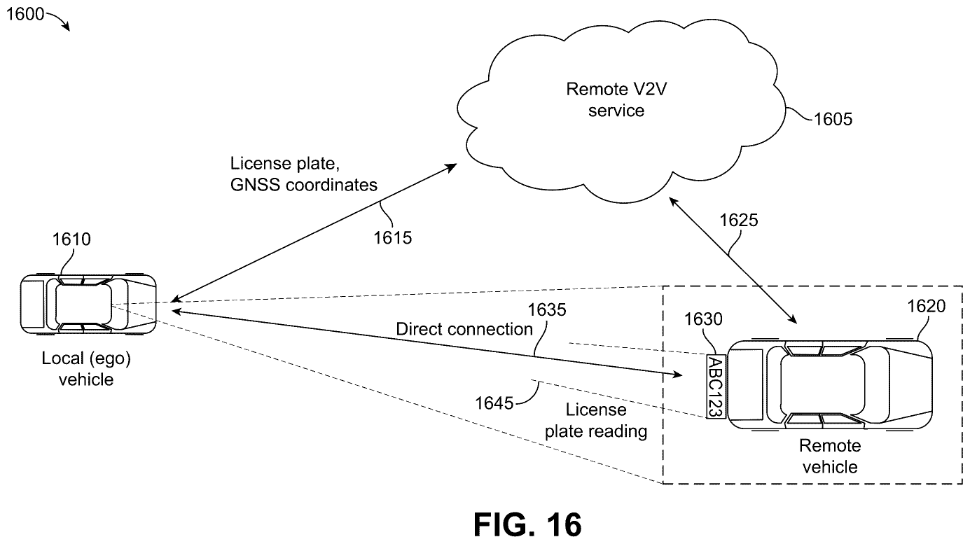

FIG. 16 shows an example of a local vehicle identifying (and verifying) a remote vehicle to establish a connection with the remote vehicle. In particular, FIG. 16 is a diagram illustrating an example of identification, verification, and connection to a vehicle 1620 (e.g., a remote vehicle). In FIG. 16, a vehicle 1610 (e.g., a local vehicle) wants to establish a connection with the vehicle 1620 (e.g., remote vehicle). To do so, the vehicle 1610 can determine a position of the vehicle 1620 (e.g., by using local GNSS measurements). The vehicle 1610 can also read the license plate 1630 (e.g., perform a license plate reading 1645) of the vehicle 1620 by obtaining obtain sensor data (e.g., image data) of the license plate 1630.

The vehicle 1610 can send, to a remote V2V service 1605 (e.g., a cloud server), a signal 1615 including the information (e.g., GNSS coordinates and license plate number) associated with the vehicle 1620. In one or more examples, the remote V2V service 1605 may contain a registry of vehicles (e.g., including vehicle 1620) with some look-up keys, such as license plate numbers, GNSS positions, vehicle appearance characteristics, or a combination thereof. The remote V2V service 1605, based on the received information, can identify and verify the vehicle 1620. Based on the identification and verification, the remote V2V server 1605 can initiate (e.g., via signal 1625) a contract with the remote vehicle 1620. After the contract is initiated, the vehicle 1610 can establish a direct connection 1635 with the vehicle 1620. In one or more examples, in either case, communications is only established with vehicles that are guaranteed to exist in the vicinity of the local vehicle, which can prevent the injection of malicious tensor data into the vehicles.

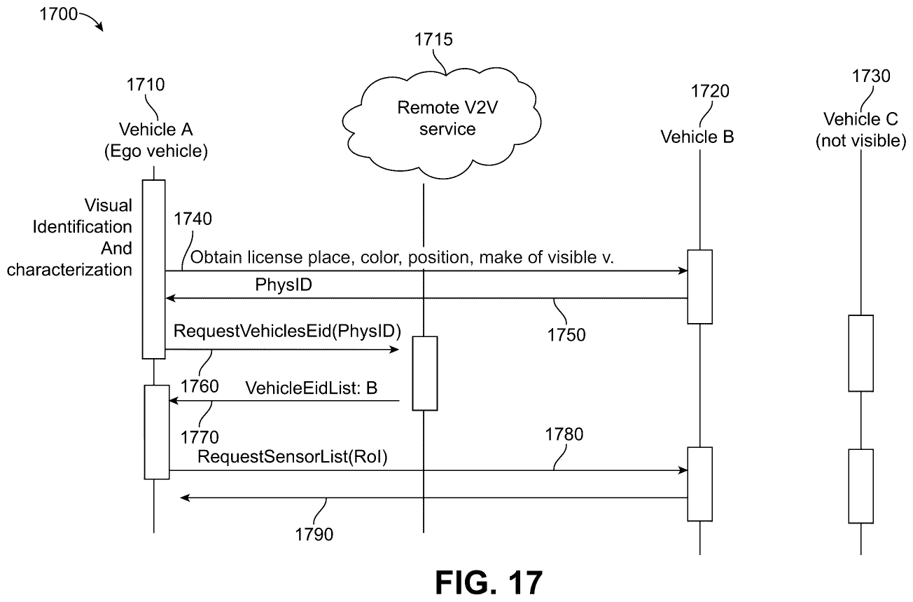

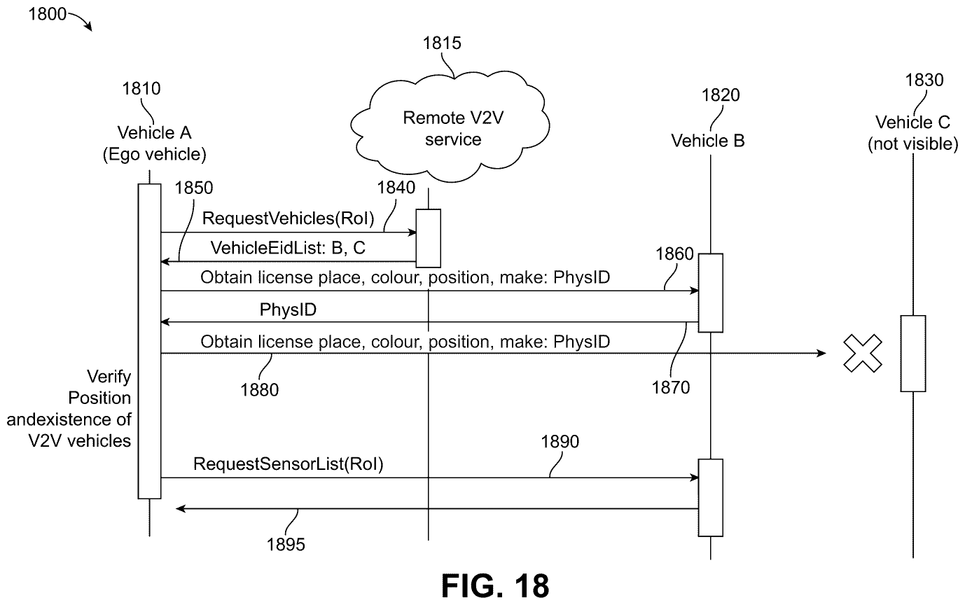

In one or more aspects, a local vehicle (e.g., an ego vehicle) may determine candidate remote vehicles in its vicinity to directly connect to (e.g., as performed in the communications 1700 of FIG. 17), or the local vehicle can ask a cloud service (e.g., remote V2V service 1605 of FIG. 16) to identify the candidate remote vehicles (e.g., as performed in the communications of FIG. 18).

FIG. 17 is a signaling diagram illustrating an example of communications 1700 for identification and verification of a vehicle (e.g., vehicle 1720), where a visual identity of the vehicle (e.g., vehicle 1720) is first established. FIG. 17 is shown to include vehicle 1710 (e.g., vehicle A, a local vehicle), vehicle 1720 (e.g., vehicle B, a remote vehicle), vehicle 1730 (e.g., vehicle C, a remote vehicle), and remote V2V service 1715. The vehicle 1720 is visible to vehicle 1710. However, the vehicle 1730 is not visible to vehicle 1710.

During operation of the communications 1700, the vehicle 1710 can send (e.g., via signal 1740) a request to the vehicle 1720 to obtain a license plate, color, position, model, make, and/or physical ID information of the vehicle 1720, which is visible to vehicle 1710. In response, the vehicle 1720 can send (e.g., via signal 1750) its physical ID (e.g., PhysID) to the vehicle 1710.

The vehicle 1710 can send (e.g., via signal 1760) a request (e.g., Request VehiclesEid(PhysID)) to the remote V2V service 1715 for the electronic identity (Eid) of the vehicle 1720. In response, the V2V service 1715 can send (e.g., via signal 1770) a response (e.g., VehicleEidList: B) to the vehicle 1710 including the Eid of the vehicle 1720. Based on receiving the Eid of the vehicle 1720, the vehicle 1710 can establish direct communications with the vehicle 1720. The vehicle 1710 can send (e.g., via signal 1780) a request (e.g., RequestSensorList(RoI)) to the vehicle 1720 requesting a listing of sensors with views of the region of interest. In response, the vehicle 1720 can send (e.g., via signal 1790) a listing of its sensors with view of the region of interest.

FIG. 18 is a signaling diagram illustrating an example of communications 1800 for identification and verification of a vehicle (e.g., vehicle 1820), where an electronic identity of the vehicle (e.g., vehicle 1820) is first established. FIG. 18 is shown to include vehicle 1810 (e.g., vehicle A, a local vehicle), vehicle 1820 (e.g., vehicle B, a remote vehicle), vehicle 1830 (e.g., vehicle C, a remote vehicle), and remote V2V service 1815. The vehicle 1820 is visible to vehicle 1810, but the vehicle 1830 is not visible to vehicle 1810.

During operation of the communications 1800, the vehicle 1810 can send (e.g., via signal 1840) a request (e.g., Request Vehicles (RoI)) to the remote V2V service 1815 requesting a listing of vehicles with views of the region of interest. In response, the V2V service 1815 can send (e.g., via signal 1850) a listing of the vehicles with views of the region of interest (VehicleEidList: B, C).

In response to receiving the listing of the vehicles, the vehicle 1810 can send (e.g., via signal 1860) a request to the vehicle 1820 to obtain a license plate, color, position, model, make, and/or physical ID information of the vehicle 1820, which is visible to vehicle 1810. In response, the vehicle 1820 can send (e.g., via signal 1870) its physical ID (e.g., PhysID) to the vehicle 1810. The vehicle 1810 can send (e.g., via signal 1880) a request to the vehicle 1830 to obtain a license plate, color, position, model, make, and/or physical ID information of the vehicle 1830. Vehicle 1830 is not visible to vehicle 1810 and, as such, the vehicle 1810 cannot independently verify the position and properties of the vehicle 1830 because the vehicle 1830 is not visible.

Based on receiving the physical ID of the vehicle 1820, the vehicle 1810 can establish direct communications with the vehicle 1820. The vehicle 1810 can send (e.g., via signal 1890) a request (e.g., RequestSensorList(RoI)) to the vehicle 1820 requesting a listing of sensors with views of the region of interest. In response, the vehicle 1820 can send (e.g., via signal 1895) a listing of its sensors with view of the region of interest.

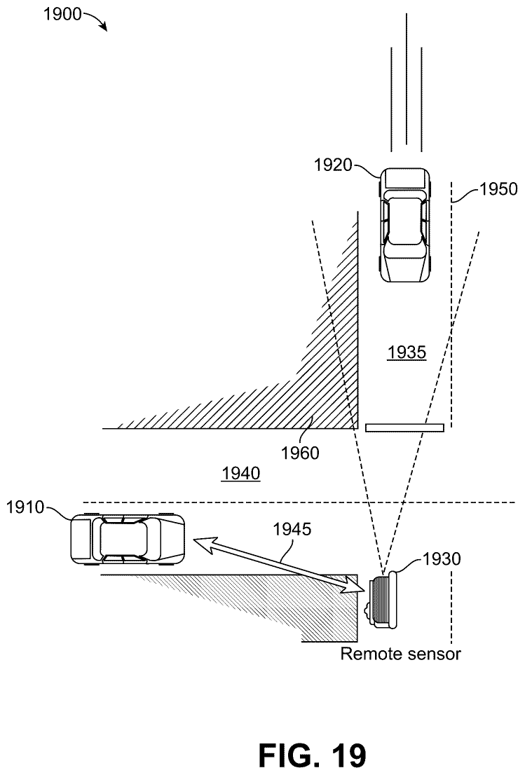

In one or more examples, a remote sensor, instead of a remote vehicle, may transfer encoder tensors to a local vehicle for LLF. FIG. 19 shows an example of a vehicle 1910 (e.g., a local vehicle, such as an ego vehicle) obtaining encoder tensors from a remote sensor 1930. In particular, FIG. 19 is a diagram illustrating an example 1900 showing a vehicle 1910 (e.g., a local vehicle), with a blocked view of an oncoming vehicle 1920, receiving information from a stationary remote sensor 1930. In FIG. 19, the stationary remote sensor 1930 is shown to be mounted at an intersection of roads 1940, 1950. The remote sensor 1930 has a view 1935. A vehicle 1920 is shown to be traveling along the road 1950. The view 1935 is shown to cover the vehicle 1920.

The vehicle 1910 is shown to be traveling along the road 1940. An obstruction 1960 located at the intersection is shown to be blocking the vehicle's 910 view of the vehicle 1920 such that the vehicle 1910 is unable to perceive the vehicle 1920. The vehicle 1910 may communicate (e.g., via signal 1945) with the remote sensor 1930 to obtain (e.g., via signal 1945), from the remote sensor 1930, encoder tensors corresponding to the view 1935 including the vehicle 1920.

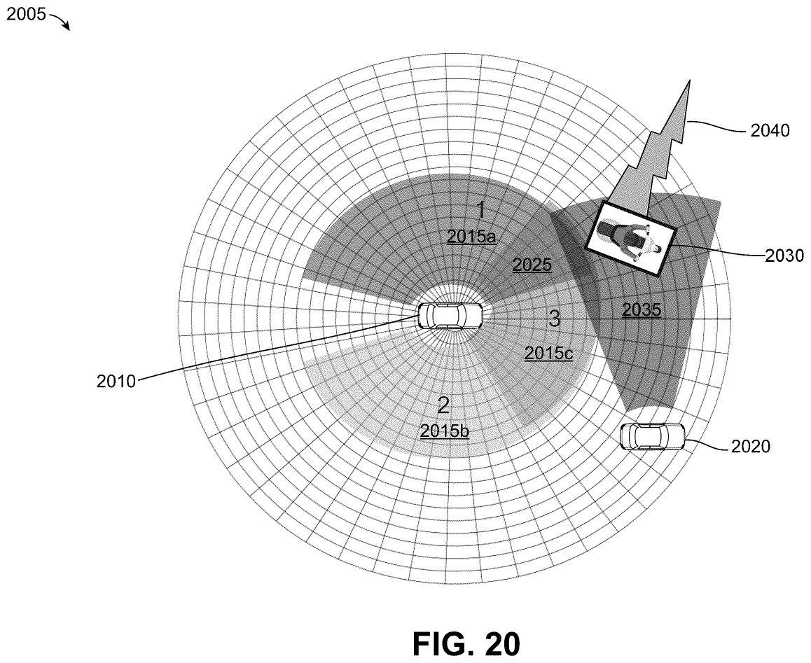

In one or more aspects, data collection may be triggered from a fleet of vehicles (e.g., vehicle 2020, a remote vehicle) based on tensor injection. FIG. 20 is a diagram illustrating an example of a top view representation 2005 of a vehicle 2010 (e.g., a local vehicle) with an object 2030 located out of range of the view, where data collection for the object 2030 is triggered 2040. In FIG. 20, the top view representation 2005 (e.g., local top view representation) includes regions (e.g., region 1 2015a, region 2 2015b, and region 3 2015c) that correspond to the views of sensors of the vehicle 2010 (e.g., a local vehicle). The regions 2015a, 2015b are shown to overlap to form overlap region 2025.

The top view representation 2005 is shown to also include a vehicle 2020 (e.g., a remote vehicle) located out of range of view (e.g., not located within the regions). The top view representation 2005 also shows a region 2035, corresponding to a view of the vehicle 2020 (e.g., remote vehicle), that includes the object 2030. The region 2035 is produced by a remote encoder tensor being projected onto the top view representation 2005 (e.g., local top view representation).

In one or more examples, to achieve optimal results of the functionality, data from several vehicles may be used. This data may or may not be obtained from an already existing fleet of vehicles performing data collection. In one or more examples, when a vehicle obtains data from a vehicle within a fleet of vehicles, data collection from the remaining vehicles within the fleet can be triggered. For example, as shown in FIG. 20, when the vehicle 2010 (e.g., local vehicle) collects data (e.g., encoder tensors) from the vehicle 2020 (e.g., remote vehicle) within a fleet of vehicles (e.g., remote vehicles), data collection may be triggered 2040 such that other vehicles (e.g., remote vehicles) within the fleet of vehicles will send their data (e.g., encoder tensors) to the vehicle 2010 (e.g., local vehicle).

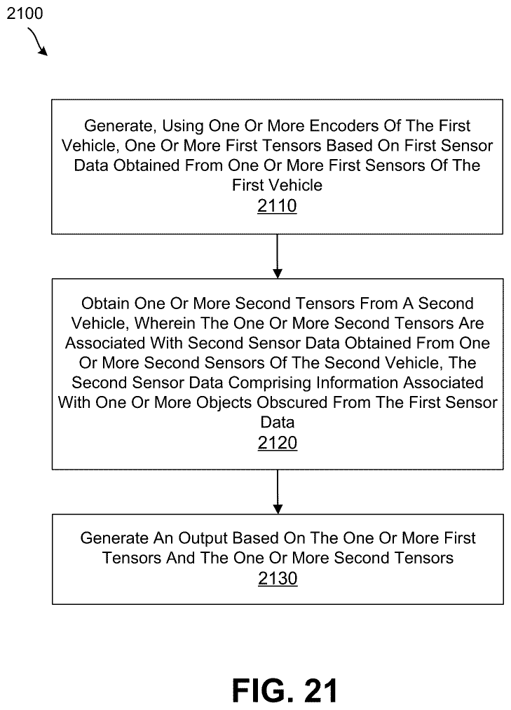

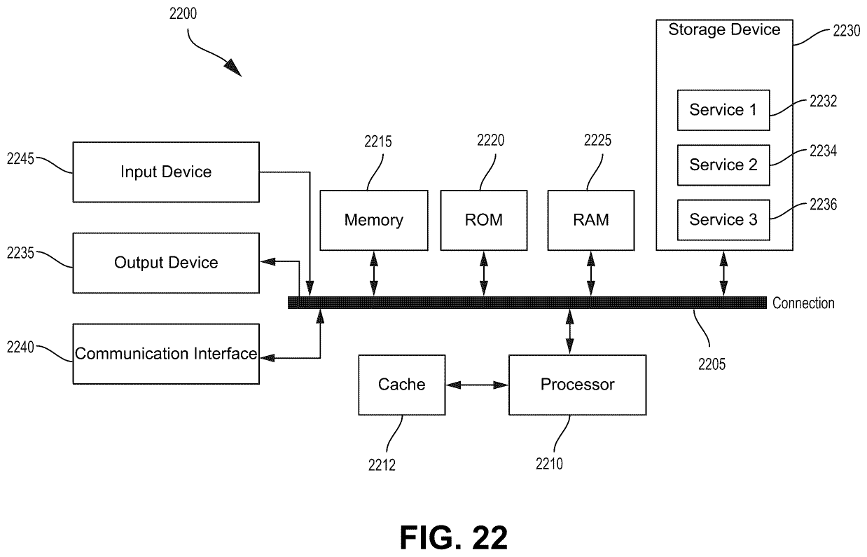

FIG. 21 is a flow chart illustrating an example of a process 2100 for vehicle communications. The process 2100 can be performed by a computing device (e.g., a computing device or computing system 2200 of FIG. 22) or by a component or system (e.g., a chipset, one or more processors central processing units (CPUs), digital signal processors (DSPs), graphics processing units (GPUs), any combination thereof, and/or other type of processor(s), or other component or system) of the computing device. In some aspects, the computing device can be part of a first vehicle. The operations of the process 2100 may be implemented as software components that are executed and run on one or more processors (e.g., processor 2210 of FIG. 22, or other processor(s)). Further, the transmission and reception of signals by the computing device in the process 2100 may be enabled, for example, by one or more antennas and/or one or more transceivers (e.g., wireless transceiver(s)).

At block 2110, the computing device (or component thereof) can generate, using one or more encoders, one or more first tensors based on first sensor data obtained from one or more first sensors of the first vehicle. In some aspects, each encoder of the one or more encoders is included in a neural network of the first vehicle.

At block 2120, the computing device (or component thereof) can obtain one or more second tensors from a second vehicle (e.g., generated by the second by the second vehicle). For example, the computing device (or component thereof) can receive the one or more second tensors from the second vehicle or can receive a compressed version (e.g., compressed data, such as a bitstream) of the one or more second tensors and decode or decompress the compressed version of the one or more second tensors. The one or more second tensors are associated with second sensor data obtained from (e.g., captured using) one or more second sensors of the second vehicle. In some aspects, the one or more first sensors and the one or more second sensors can include image sensor(s), radar sensor(s), light detection and ranging (Lidar) sensor(s), and/or other types of sensors. The second sensor data includes information associated with one or more regions (e.g., which may include one or more objects) obscured from the first sensor data (e.g., based on a view of the one or more first sensors being obstructed or blocked, the one or more first sensors being broken, the one or more first sensors being dirty, the one or more first sensors being blinded by low sun or oncoming headlights, the one or more first sensors sensor (e.g., a radar or LIDAR sensor) experiencing interference from other active sensors from other vehicles or road-side devise or systems (e.g., RSUs), any combination thereof, and/or other factor(s) affecting the view of the one or more first sensors). In some aspects, the computing device (or component thereof) can determine a region of interest based on a view of at least one first sensor of the one or more first sensors. In some cases, the computing device (or component thereof) can transmit (or output for transmission), to the second vehicle, a request for a sensor listing including the one or more second sensors with a view of the region of interest. In some examples, the computing device (or component thereof) can receive, from the second vehicle, the sensor listing. The computing device (or component thereof) transmit (or output for transmission), to the second vehicle based on the sensor listing, a request to subscribe to the one or more second sensors in the sensor listing. In some aspects, the computing device (or component thereof) can transmit (or output for transmission), to a cloud service, a request for a vehicle listing. The vehicle listing includes a plurality of vehicles with sensors having views of the region of interest. The plurality of vehicles of or included in the vehicle listing includes the second vehicle.

In some aspects, the computing device (or component thereof) can transmit (or output for transmission), to the second vehicle, a request for information associated with the second vehicle. The computing device (or component thereof) can receive, from the second vehicle, the information based on the request. The computing device (or component thereof) can establish, based on the information, direct communications with the second vehicle. For instance, the computing device (or component thereof) can receive the one or more second tensors from the second vehicle over the direct communications connection. In some cases, the information includes a license plate number of the second vehicle, a color of the second vehicle, a position of the second vehicle, a make of the second vehicle, a model of the second vehicle, a physical identification (ID) of the second vehicle, any combination thereof, and/or other information.

At block 2130, the computing device (or component thereof) can generate an output based on the one or more first tensors and the one or more second tensors. For example, to generate the output based on the one or more first tensors and the one or more second tensors, the computing device (or component thereof) can fuse the one or more first tensors and the one or more second tensors to generate a third tensor. In some aspects, each tensor of the one or more first tensors and each tensor of the one or more second tensors represents a perspective view of an environment of the first vehicle. In some cases, the third tensor represents a bird's eye view (BEV) of the environment of the first vehicle. In some aspects, to fuse the one or more first tensors and the one or more second tensors, the computing device (or component thereof) can project, using a view transform, the one or more first tensors and the one or more second tensors onto a top view representation of the first vehicle to generate the third tensor. In some aspects, the computing device (or component thereof) can receive, from vehicles within a fleet of vehicles including the second vehicle, one or more fourth tensors associated with third sensor data (e.g., the third sensor data can be associated with the one or more regions obscured within the first sensor data). The one or more fourth tensors can be fused with the one or more first tensors and the one or more second tensors to generate the third tensor.

At block 2140, the computing device (or component thereof) can process the third tensor to generate an output. In some aspects, to process the third tensor to generate the output, the computing device (or component thereof) can detect, based on the third tensor, one or more objects to generate an object detection output. In some aspects, to process the third tensor, the computing device (or component thereof) can generate, using one or more bird's eye view (BEV) encoders and one or more decoders, one or more output tensors representing the object detection output. In some cases, each output tensor of the one or more output tensors represents at least one property of the one or more objects. For instance, the at least one property can include a respective probability of each object being located at a respective location within an environment of the first vehicle, a respective orientation of each object, a respective class of each object, a respective size of each object, a respective velocity of each object, any combination thereof, and/or other property. In some aspects, the third tensor can be processed to generate other types of output, such as for building a model of a surrounding environment of the vehicle, including static structures and a road on which the vehicle is traveling (e.g., for extraction of information not typically available in a map, such as a damaged road or structure, temporary construction sites, signs, lane markings, etc.).

In some cases, the computing device of the process 2100 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of the process 2100 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 2100 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 2100 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

FIG. 22 is a block diagram illustrating an example of a computing system 2200, which may be employed for inter-vehicle low-level fusion tensor transfer. In particular, FIG. 22 illustrates an example of computing system 2200, which can be for example any computing device making up internal computing system, a remote computing system, a camera, or any component thereof in which the components of the system are in communication with each other using connection 2205. Connection 2205 can be a physical connection using a bus, or a direct connection into processor 2210, such as in a chipset architecture. Connection 2205 can also be a virtual connection, networked connection, or logical connection.

In some aspects, computing system 2200 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 2200 includes at least one processing unit (CPU or processor) 2210 and connection 2205 that communicatively couples various system components including system memory 2215, such as read-only memory (ROM) 2220 and random access memory (RAM) 2225 to processor 2210. Computing system 2200 can include a cache 2212 of high-speed memory connected directly with, in close proximity to, or integrated as part of processor 2210.

Processor 2210 can include any general purpose processor and a hardware service or software service, such as services 2232, 2234, and 2236 stored in storage device 2230, configured to control processor 2210 as well as a special-purpose processor where software instructions are incorporated into the actual processor design. Processor 2210 may essentially be a completely self-contained computing system, containing multiple cores or processors, a bus, memory controller, cache, etc. A multi-core processor may be symmetric or asymmetric.

To enable user interaction, computing system 2200 includes an input device 2245, which can represent any number of input mechanisms, such as a microphone for speech, a touch-sensitive screen for gesture or graphical input, keyboard, mouse, motion input, speech, etc. Computing system 2200 can also include output device 2235, which can be one or more of a number of output mechanisms. In some instances, multimodal systems can enable a user to provide multiple types of input/output to communicate with computing system 2200.

Computing system 2200 can include communications interface 2240, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

| The communications interface 2240 may also include one or more range sensors (e.g., LiDAR sensors, laser range finders, RF radars, ultrasonic sensors, and infrared (IR) sensors) configured to collect data and provide measurements to processor 2210, whereby processor 2210 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 2240 may also include one or more Global Navigation Satellite System (GNSS) receivers or transceivers that are used to determine a location of the computing system 2200 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 2230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 2230 can include software services, servers, services, etc., that when the code that defines such software is executed by the processor 2210, it causes the system to perform a function. In some aspects, a hardware service that performs a particular function can include the software component stored in a computer-readable medium in connection with the necessary hardware components, such as processor 2210, connection 2205, output device 2235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for vehicle communications at a first vehicle, the apparatus comprising: at least one memory; and at least one processor coupled to the at least one memory and configured to: generate, using one or more encoders, one or more first tensors based on first sensor data obtained from one or more first sensors of the first vehicle; obtain one or more second tensors from a second vehicle, wherein the one or more second tensors are associated with second sensor data obtained from one or more second sensors of the second vehicle, the second sensor data comprising information associated with one or more regions obscured from the first sensor data; generate an output based on the one or more first tensors and the one or more second tensors.

Aspect 2. The apparatus of Aspect 1, wherein the at least one processor is configured to determine a region of interest based on a view of at least one first sensor of the one or more first sensors.

Aspect 3. The apparatus of Aspect 2, wherein the at least one processor is configured to output, for transmission to the second vehicle, a request for a sensor listing comprising the one or more second sensors with a view of the region of interest.

Aspect 4. The apparatus of Aspect 3, wherein the at least one processor is configured to: receive, from the second vehicle, the sensor listing; and output, for transmission to the second vehicle based on the sensor listing, a request to subscribe to the one or more second sensors in the sensor listing.

Aspect 5. The apparatus of Aspect 4, wherein the at least one processor is configured to output, for transmission to a cloud service, a request for a vehicle listing, the vehicle listing comprising a plurality of vehicles with sensors having views of the region of interest, wherein the plurality of vehicles of the vehicle listing comprises the second vehicle.

Aspect 6. The apparatus of any of Aspects 1 to 5, wherein the at least one processor is configured to: output, for transmission to the second vehicle, a request for information associated with the second vehicle; receive, from the second vehicle, the information based on the request; and establish, based on the information, direct communications with the second vehicle.

Aspect 7. The apparatus of Aspect 6, wherein the information comprises at least one of a license plate number of the second vehicle, a color of the second vehicle, a position of the second vehicle, a make of the second vehicle, a model of the second vehicle, a physical identification (ID) of the second vehicle, or any combination thereof.

Aspect 8. The apparatus of any of Aspects 1 to 7, wherein the at least one processor is configured to receive, from vehicles within a fleet of vehicles comprising the second vehicle, one or more fourth tensors associated with third sensor data, wherein the third sensor data is associated with the one or more regions obscured within the first sensor data.

Aspect 9. The apparatus of any of Aspects 1 to 8, wherein, to generate the output based on the one or more first tensors and the one or more second tensors, the at least one processor is configured to: fuse the one or more first tensors and the one or more second tensors to generate a third tensor; and process the third tensor to generate an output.

Aspect 10. The apparatus of Aspect 9, wherein, to fuse the one or more first tensors and the one or more second tensors, the at least one processor is configured to project, using a view transform, the one or more first tensors and the one or more second tensors onto a top view representation of the first vehicle to generate the third tensor.

Aspect 11. The apparatus of any of Aspects 9 or 10, wherein, to process the third tensor to generate the output, the at least one processor is configured to detect, based on the third tensor, one or more objects to generate an object detection output.

Aspect 12. The apparatus of Aspect 11, wherein, to process the third tensor, the at least one processor is configured to generate, using one or more bird's eye view (BEV) encoders and one or more decoders, one or more output tensors representing the object detection output.

Aspect 13. The apparatus of Aspect 12, wherein each output tensor of the one or more output tensors represents at least one property of the one or more objects.

Aspect 14. The apparatus of Aspect 13, wherein the at least one property includes at least one of a respective probability of each object being located at a respective location within an environment of the first vehicle, a respective orientation of each object, a respective class of each object, a respective size of each object, a respective velocity of each object, or any combination thereof.

Aspect 15. The apparatus of any of Aspects 9 to 14, wherein the third tensor represents a bird's eye view (BEV) of the environment of the first vehicle.

Aspect 16. The apparatus of any of Aspects 1 to 15, wherein each tensor of the one or more first tensors and each tensor of the one or more second tensors represents a perspective view of an environment of the first vehicle.

Aspect 17. The apparatus of any of Aspects 1 to 16, wherein each sensor of the one or more first sensors and each sensor of the one or more second sensors is a respective image sensor, a respective radar sensor, or respective a light detection and ranging (Lidar) sensor.

Aspect 18. The apparatus of any of Aspects 1 to 17, wherein each encoder of the one or more encoders is included in a neural network of the first vehicle.

Aspect 19. A method for vehicle communications at a first vehicle, the method comprising: generating, by one or more encoders of the first vehicle, one or more first tensors based on first sensor data obtained from one or more first sensors of the first vehicle; obtaining one or more second tensors from a second vehicle, wherein the one or more second tensors are associated with second sensor data obtained from one or more second sensors of the second vehicle, the second sensor data comprising information associated with one or more regions obscured from the first sensor data; and generating an output based on the one or more first tensors and the one or more second tensors.

Aspect 20. The method of Aspect 19, further comprising determining a region of interest based on a view of at least one first sensor of the one or more first sensors.

Aspect 21. The method of Aspect 20, further comprising transmitting, to the second vehicle, a request for a sensor listing comprising the one or more second sensors with a view of the region of interest.

Aspect 22. The method of Aspect 21, further comprising: receiving, from the second vehicle, the sensor listing; and transmitting, to the second vehicle based on the sensor listing, a request to subscribe to the one or more second sensors in the sensor listing.

Aspect 23. The method of Aspect 22, further comprising transmitting, to a cloud service, a request for a vehicle listing, the vehicle listing comprising a plurality of vehicles with sensors having views of the region of interest, wherein the plurality of vehicles of the vehicle listing comprises the second vehicle.

Aspect 24. The method of any of Aspects 19 to 23, wherein further comprising: transmitting, to the second vehicle, a request for information associated with the second vehicle; receiving, from the second vehicle, the information based on the request; and establish, based on the information, direct communications with the second vehicle.

Aspect 25. The method of Aspect 24, wherein the information comprises at least one of a license plate number of the second vehicle, a color of the second vehicle, a position of the second vehicle, a make of the second vehicle, a model of the second vehicle, a physical identification (ID) of the second vehicle, or any combination thereof.

Aspect 26. The method of any of Aspects 19 to 25, further comprising receiving, from vehicles within a fleet of vehicles comprising the second vehicle, one or more fourth tensors associated with third sensor data, wherein the third sensor data is associated with the one or more regions obscured within the first sensor data.

Aspect 27. The method of any of Aspects 19 to 26, wherein generating the output based on the one or more first tensors and the one or more second tensors comprises: fusing the one or more first tensors and the one or more second tensors to generate a third tensor; and processing the third tensor to generate an output.

Aspect 28. The method of Aspect 27, wherein fusing the one or more first tensors and the one or more second tensors comprises projecting, using a view transform, the one or more first tensors and the one or more second tensors onto a top view representation of the first vehicle to generate the third tensor.

Aspect 29. The method of any of Aspects 27 or 28, wherein processing the third tensor to generate the output comprises detecting, based on the third tensor, one or more objects to generate an object detection output.

Aspect 30. The method of Aspect 29, wherein processing the third tensor comprises generating, using one or more bird's eye view (BEV) encoders and one or more decoders, one or more output tensors representing the object detection output.

Aspect 31. The method of Aspect 30, wherein each output tensor of the one or more output tensors represents at least one property of the one or more objects.

Aspect 32. The method of Aspect 31, wherein the at least one property includes at least one of a respective probability of each object being located at a respective location within an environment of the first vehicle, a respective orientation of each object, a respective class of each object, a respective size of each object, a respective velocity of each object, or any combination thereof.

Aspect 33. The method of any of Aspects 27 to 32, wherein the third tensor represents a bird's eye view (BEV) of the environment of the first vehicle.

Aspect 34. The method of any of Aspects 19 to 33, wherein each tensor of the one or more first tensors and each tensor of the one or more second tensors represents a perspective view of an environment of the first vehicle.

Aspect 35. The method of any of Aspects 19 to 34, wherein each sensor of the one or more first sensors and each sensor of the one or more second sensors is a respective image sensor, a respective radar sensor, or respective a light detection and ranging (Lidar) sensor.

Aspect 36. The method of any of Aspects 19 to 35, wherein each encoder of the one or more encoders is included in a neural network of the first vehicle.

Aspect 37. A non-transitory computer-readable medium having stored thereon instructions that, when executed by at least one processor, cause the at least one processor to perform operations according to any of Aspects 18 to 33.

Aspect 38. An apparatus for vehicle communications, the apparatus including one or more means for performing operations according to any of Aspects 18 to 33.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for vehicle communications at a first vehicle, the apparatus comprising:
at least one memory; and
at least one processor coupled to the at least one memory and configured to:
generate, using one or more encoders, one or more first tensors based on first sensor data obtained from one or more first sensors of the first vehicle;
obtain one or more second tensors from a second vehicle, wherein the one or more second tensors are associated with second sensor data obtained from one or more second sensors of the second vehicle, the second sensor data comprising information associated with one or more regions obscured from the first sensor data;
generate an output based on the one or more first tensors and the one or more second tensors.

2. The apparatus of claim 1, wherein the at least one processor is configured to determine a region of interest based on a view of at least one first sensor of the one or more first sensors.

3. The apparatus of claim 2, wherein the at least one processor is configured to output, for transmission to the second vehicle, a request for a sensor listing comprising the one or more second sensors with a view of the region of interest.

4. The apparatus of claim 3, wherein the at least one processor is configured to:
receive, from the second vehicle, the sensor listing; and
output, for transmission to the second vehicle based on the sensor listing, a request to subscribe to the one or more second sensors in the sensor listing.

5. The apparatus of claim 4, wherein the at least one processor is configured to output, for transmission to a cloud service, a request for a vehicle listing, the vehicle listing comprising a plurality of vehicles with sensors having views of the region of interest, wherein the plurality of vehicles of the vehicle listing comprises the second vehicle.

6. The apparatus of claim 1, wherein the at least one processor is configured to:
output, for transmission to the second vehicle, a request for information associated with the second vehicle;
receive, from the second vehicle, the information based on the request; and
establish, based on the information, direct communications with the second vehicle.

7. The apparatus of claim 6, wherein the information comprises at least one of a license plate number of the second vehicle, a color of the second vehicle, a position of the second vehicle, a make of the second vehicle, a model of the second vehicle, a physical identification (ID) of the second vehicle, or any combination thereof.

8. The apparatus of claim 1, wherein the at least one processor is configured to receive, from vehicles within a fleet of vehicles comprising the second vehicle, one or more fourth tensors associated with third sensor data, wherein the third sensor data is associated with the one or more regions obscured within the first sensor data.

9. The apparatus of claim 1, wherein, to generate the output based on the one or more first tensors and the one or more second tensors, the at least one processor is configured to:
fuse the one or more first tensors and the one or more second tensors to generate a third tensor; and
process the third tensor to generate an output.

10. The apparatus of claim 9, wherein, to fuse the one or more first tensors and the one or more second tensors, the at least one processor is configured to project, using a view transform, the one or more first tensors and the one or more second tensors onto a top view representation of the first vehicle to generate the third tensor.

11. The apparatus of claim 9, wherein, to process the third tensor to generate the output, the at least one processor is configured to detect, based on the third tensor, one or more objects to generate an object detection output.

12. The apparatus of claim 11, wherein, to process the third tensor, the at least one processor is configured to generate, using one or more bird's eye view (BEV) encoders and one or more decoders, one or more output tensors representing the object detection output.

13. The apparatus of claim 12, wherein each output tensor of the one or more output tensors represents at least one property of the one or more objects.

14. The apparatus of claim 13, wherein the at least one property includes at least one of a respective probability of each object being located at a respective location within an environment of the first vehicle, a respective orientation of each object, a respective class of each object, a respective size of each object, a respective velocity of each object, or any combination thereof.

15. The apparatus of claim 9, wherein the third tensor represents a bird's eye view (BEV) of the environment of the first vehicle.

16. The apparatus of claim 1, wherein each tensor of the one or more first tensors and each tensor of the one or more second tensors represents a perspective view of an environment of the first vehicle.

17. The apparatus of claim 1, wherein each sensor of the one or more first sensors and each sensor of the one or more second sensors is a respective image sensor, a respective radar sensor, or respective a light detection and ranging (Lidar) sensor.

18. The apparatus of claim 1, wherein each encoder of the one or more encoders is included in a neural network of the first vehicle.

19. A method for vehicle communications at a first vehicle, the method comprising:
generating, by one or more encoders of the first vehicle, one or more first tensors based on first sensor data obtained from one or more first sensors of the first vehicle;
obtaining one or more second tensors from a second vehicle, wherein the one or more second tensors are associated with second sensor data obtained from one or more second sensors of the second vehicle, the second sensor data comprising information associated with one or more regions obscured from the first sensor data; and
generating an output based on the one or more first tensors and the one or more second tensors.

20. The method of claim 19, further comprising determining a region of interest based on a view of at least one first sensor of the one or more first sensors.
